(19) United States
(12) Patent Application Publication
(10) Pub. No.: US 2008/0313057 A1
(43) Pub. Date: Dec. 18, 2008

(54) SYSTEM AND METHOD FOR THE COLLABORATIVE SOLICITATION OF KNOWLEDGE BASE CONTENT, SERVICES AND PRODUCTS

(76) Inventors: Gordon Campbell Gooch, New York, NY (US); John Joseph Carlino, New York, NY (US)

Correspondence Address: DANIEL B. SCHEIN, PH.D., ESQ., INC., P. O. BOX 68128, Virginia Beach, VA, 23471, US

(21) Appl. No.: 12/140,838

(22) Filed: Jun. 17, 2008

Related U.S. Application Data
(60) Provisional application No. 60/929,215, filed on Jun. 18, 2007.

(51) Int. Cl. G06Q 30/00; G06F 7/00; G06Q 20/00

(52) U.S. Cl. 705/27; 707/104.1; 705/35; 707/E17.001

(57) ABSTRACT

A system and method for soliciting a content item, which may include but is not limited to one or more products, services and/or acts, based on an assumption that if a content item can be identified for which a single Internet user has a desire, amongst the millions of world-wide Internet users, there is likely a similar desire among many hundreds or even thousands of Internet users. Even if a content item has not been provided and/or produced, and/or has not been posted to the Internet, the approach assumes that among the millions of Internet users, at least one user has the knowledge and/or skill to produce and/or provide the desired content item, and that by collaboratively grouping relatively nominal sums from a large number of interested Internet users, an individual and/or group of individuals may be sufficiently economically motivated to produce and/or provide and/or post the content item.

### INCORPORATION BY REFERENCE

This application claims the benefit of U.S. provisional application No. 60/929,215, “Collaborative Solicitation of Knowledge Base Content, Services and Products,” filed by Gordon Campbell Gooch and John Joseph Carlino on Jun. 18, 2007, which is incorporated herein by reference in its entirety.

### BACKGROUND

This disclosure generally relates to knowledge base information systems used to solicit and procure knowledge base content, services and/or products.

The Internet currently provides standards based network connectivity to over 900 million users throughout the world. In addition, there are over 108 million information sites, e.g., World-Wide-Web (WWW) based sites, File Transfer Protocol (FTP) based sites, etc., accessible to these users via the Internet. Such an unprecedented level of connectivity coupled with such an unprecedented number of information sites allow information to be easily and efficiently disseminated throughout the world.

The information sources accessible via the Internet may be made available by government organizations, e.g., national, provincial and local government organizations; civilian organizations, e.g., corporations, universities, charitable organizations, etc.; and individuals. Such sites post information that the respective organizations or individuals desire to post based on one of a self-serving need to promote a product or idea, a perceived need of the user community and/or a perceived interest of an anticipated target audience.

The Internet capitalizes on the fact that once information has been produced and placed in electronic form, the electronic information may be disseminated quickly and inexpensively to an unlimited number of people throughout the world via the Internet at very little added cost.

In addition, the physical and software infrastructure of the Internet is based on a distributed architecture or framework. Such a framework allows the cost of establishing the infrastructure that supports the Internet to be distributed to those governments, organizations and individuals within society that have an interest in establishing, or extending with respect connectivity and/or bandwidth, the type information sharing, as described above, that the Internet can provide.

The ability of the Internet to disseminate electronic information quickly and inexpensively to an unlimited number of people throughout the world via the Internet at very little cost, coupled with the Internet's ability to distribute infrastructure costs to governments, organizations and individuals within society that are interested and willing to bear those costs, coupled with nominal costs associated with an individual user gaining access to the Internet versus the information access benefits received in return, may be considered some of the driving economic forces that have allowed the Internet to flourish.

For example, the Internet is widely used to facilitate electronic commerce. The inexpensive connectivity offered by the Internet allows potential suppliers and potential buyers to communicate with each other and to conduct business transactions, for example, such as transactions related to the buying and selling of products and services.

U.S. Pat. No. 6,928,416 discloses a virtual client discount pricing system and method that allows a number of individuals or entities, referred to as participants, to create a virtual client for the purpose of obtaining a discounted rate for purchasing, leasing or renting products and services, especially investment management services. When the participants of the virtual client access goods or services from the provider, each of the participants receives a discounted rate from the provider using the virtual client, as compared to each of the participants individually accessing goods or services from the provider.

U.S. Pat. No. 6,671,674 discloses a computer-based auction and sale system in which a nonredeemable fee is collected from each auction participant to enter a bidder pool for a particular item. The collective nonredeemable fees from all bidders are then allocated to reduce the minimum bid required to purchase the item for the seller's asking price and to pay the transactional costs associated with the auction.

U.S. Pat. No. 7,292,990 discloses a system and method for compensating a software developer that includes soliciting software developers for the submission of computer software components, receiving software components in response to the solicitation from the developers, evaluating the received software components, selecting one or more of the submissions for potential distribution to the public, and allotting the proceeds from the distribution to the developers.

U.S. Pat. No. 7,080,070 discloses a system and methods for browsing a database of items and conducting associated transactions. An electronic commerce system provides various features for assisting customers in locating items and generating orders from a merchant's electronic catalog, and for assisting customers and merchants in communicating about such orders. A user-definable categories feature allows customers and/or merchants to define search queries for searching the electronic catalog, and to store these search queries under user-defined category names for subsequent use.

U.S. Pat. Application Publication No. 20060178942 discloses a method and system for delivering a digital good. The system includes an interface to receive a digital goods package from the seller, the digital goods package including the digital good and a buyer identifier. A digital goods database is provided to store the digital goods package, with an identifier extractor being provided to extract the buyer identifier from the digital goods package. The system further includes a notifier to notify the buyer, based on the buyer identifier, that the digital good has been received from the seller and is ready to be collected by the buyer, wherein, after having sent the notification that the digital good is ready to be collected, the system allows the buyer to access and retrieve the digital good.

The systems described above facilitate commercial transactions by leveraging improved communication and data sharing between potential buyers and potential sellers. However, none of the disclosed approaches allow a first solicitation participant to define one or more desired goods and/or services in the form of an outstanding solicitation and then allow a plurality of other solicitation participants to contribute funds to the solicitation, thereby allowing the solicitation participants to pool their respective financial contributions to entice one or more yet unidentified providers to provide products and services that satisfy the outstanding solicitation.

### SUMMARY

Despite advancements in technologies that support the physical infrastructure of the Internet, despite enhancements in technologies that facilitate the dissemination of information from information sites, and despite advancements in search technologies that allow existing electronic information to be located by users of the respective Internet accessible sites, users are often unable to find via the Internet a content item that satisfies a specific information, service or product need.

As used here, and in the description below, the term content item refers to one or more of a product and/or service. For example, a content item may include electronic information products, such as software, books, photographs, sound recordings and films that have been formatted and stored in an electronic form capable of being stored on a computer readable storage media and/or distributed via a transmission media, such as the Internet, a private computer network or other transmission media. A content item may also include a physical product that has not, or cannot, be stored in an electronically transmittable form, such as a bound book, printed material, food, medicine, appliances, computer hardware, storage media containing software, books, photographs, sound recordings and films, etc. Further, a content item may include a service, or action, that may be performed for the benefit of, or at the request of, an individual or group of individuals.

The inability to locate a content item may be caused by the inability of existing search engines and/or information indexes to allow the user to locate a desired content item, even though information describing an applicable content item that would meet the user's information, service or product need has been generated, placed in electronic form, and posted on an Internet information site. However, in cases in which a user requires a specific content item containing specialized information, or in which a user requires a specialized item or service, content items that would satisfy the user's need may not be available from any information site on the Internet. Please note that, in the description below, posting electronic information on an Internet information site that describes a content item, makes users aware of the existence or availability of, and/or provides access to a content item may be referred to as posting the content item.

Although a desired content item has not been posted on an Internet information site, it is often unlikely that the content item does not exist, and/or that the knowledge and ability to generate such a content item does not exist among the knowledge retained in the minds, and/or within the skill set of one or more of the millions of Internet users.

Organizations often invest the funds necessary to generate and collect content items that are believed to be of interest to a large number of users, merely so the organization can post the content item on an Internet site to increase Internet user traffic to the site, and thereby increase advertising revenues. Advertising displayed to a user accessing electronic information related to a specific content item may be tailored, based on the content item being accessed, to meet the perceived interests of the user. For example, a user interested in a specialized roofing technique, material, or tool, may likely be interested in similar roofing related content items. Further, a user interested in a specific photo, video recording or audio recording or news item is likely to be interested in photos, video recordings, audio recordings or news item pertaining to the same and/or related subjects.

Therefore, if a desired content item is not available via an existing Internet information site, a reason for the deficiency may be that the desire for such a content item has not been identified by those capable of providing the content item; or that the size of the perceived interest group, and associated increase in advertising returns, is believed to be too small to justify the cost of generating the content item; or that a good Samaritan or charity or educational organization, that would otherwise produce the content item, does not have the funding or other resources to produce the content item; and/or that the individual or individuals capable of providing the content item, e.g., electronic information product, physical product, action or service, have not been informed of the desire for the content item, and/or have not been offered sufficient economic incentive, e.g., sufficient cash, to provide the content item.

As addressed above, the distributed nature of the Internet, and the inherent distribution of costs associated with such an architecture, has contributed to the rapid expansion of the Internet. Further, as addressed above, the ability to sell multiple copies of an item, and/or the ability to increase advertising revenues as a result of the generated content item, allows companies and/or groups to invest in the development of content items for which they believe a high demand exists, because the cost of development is likely to be recouped and profits are likely to be gained after the content item has been developed. Although such an approach may involve a measure of risk, if the expected market is large enough to allow such an organization to recoup its costs, or if a significant portion of the cost of producing the content item is likely to be recouped, the added incentive of easy profits once costs have been recouped may provide sufficient incentive for the content item to be produced.

Hence, a need remains for approaches that allow members of the Internet user community to identify, or define, content items for which one or more members of the Internet community believe there is a need, for approaches that collect funds to encourage production of content items that satisfy the identified need, for approaches that locate potential providers of an identified content item, for approaches that deliver a produced content item, or response item, from a provider to the members of the Internet community funding production of the content item, for approaches that allow a quality review of produced content items, or response items, to determine a level of effectiveness of the produced content item in meeting the identified need, for approaches that allow an identified content item to be refined, so that subsequent content items may be produced that fully addresses the identified need, and for approaches that deliver funds to those generating and/or providing the identified content items.

The described approach for collaborative solicitation of knowledge base content, services and products is based, in part, on an expectation that individuals are not unique in their interests, desires and needs for content items, services and products, and that if a content item can be identified for which a single Internet user has a need, amongst the millions of Internet users, there is likely a similar, or even a stronger desire among many thousands of Internet users. Further, the described approach for collaborative solicitation of knowledge base content, services and products is based, in part, on an expectation that even if a content item has not been produced, and/or has not been posted to the Internet, amongst the millions of Internet users, at least one user has the knowledge and/or skill to produce a desired content item, and/or may have already produced such an item, or knows someone who has, and that by collaboratively grouping relatively nominal sums from a large number of interested Internet users, from amongst the millions of Internet users, an individual and/or group may be sufficiently economically motivated to produce and to post the desired content item, i.e., to perform a desired service and/or to make available a desired product or service.

### BRIEF DESCRIPTION OF THE DRAWINGS

Example embodiments of a collaborative solicitation system and example embodiments of a collaborative solicitation process will be described with reference to the accompanying drawings, wherein like numerals represent like parts, and in which;

FIG. 1 is a system level block diagram of an exemplary collaborative solicitation server, that supports the collaborative solicitation of knowledge base content items, services and products;

FIG. 2 is a block diagram of an exemplary solicitation management unit within the collaborative solicitation server shown in FIG. 1;

FIG. 3 is a block diagram of an exemplary membership management unit within the collaborative solicitation server shown in FIG. 1;

FIG. 4 is a block diagram of an exemplary knowledge base management unit within the collaborative solicitation server shown in FIG. 1;

FIG. 5 is a block diagram of an exemplary video/audio streaming unit within the collaborative solicitation server shown in FIG. 1;

FIG. 6 is a schematic diagram of an exemplary local area network (LAN), wide area network (WAN) and/or Internet based network that provides connectivity between a collaborative solicitation server of FIG. 1 and network connected apparatus, or collaborative solicitation stations, or member stations, participating in a collaborative solicitation;

FIG. 7, FIG. 8, FIG. 9, FIG. 10 and FIG. 11 present a flow diagram of an exemplary process executed by a collaborative solicitation server to execute an exemplary collaborative solicitation process;

FIG. 12 is an example of top-level display that may be presented to a user via a LAN, WAN and/or Internet based network connection as part of a user interface supported by an exemplary embodiment of the collaborative solicitation server shown in FIG. 1;

FIG. 13 is an example of a user interface display that may be presented to a user via selection of the channels tab shown in FIG. 12, followed by selection of the search by keywords tab;

FIG. 14 is an example of a user interface display that may be presented to a user via selection of the channels tab shown in FIG. 12, followed by selection of the browse by category/subcategory tab;

FIG. 15 is an example of a user interface display that may be presented to a user via selection of the my account tab shown in FIG. 12, followed by selection of the my profile tab;

FIG. 16 is an example of a user interface display that may be presented to a user via selection of the my account tab shown in FIG. 12, followed by selection of the my on demand tab;

FIG. 17 is an example of a user interface display that may be presented to a user via selection of the my account tab shown in FIG. 12, followed by selection of the my $ for knowledge tab;

FIG. 18 is an example of a user interface display that may be presented to a user via selection of the my account tab shown in FIG. 12, followed by selection of the review/rate tab;

FIG. 19 is an example of a user interface display that may be presented to a user via selection of the demand tab shown in FIG. 12;

FIG. 20 is an example of a user interface display that may be presented to a user via selection of the upload tab shown in FIG. 12; and

FIG. 21 is an example of a user interface display that may be presented to a user via selection of a post response button, as shown in FIG. 13.

### DETAILED DESCRIPTION OF EMBODIMENTS

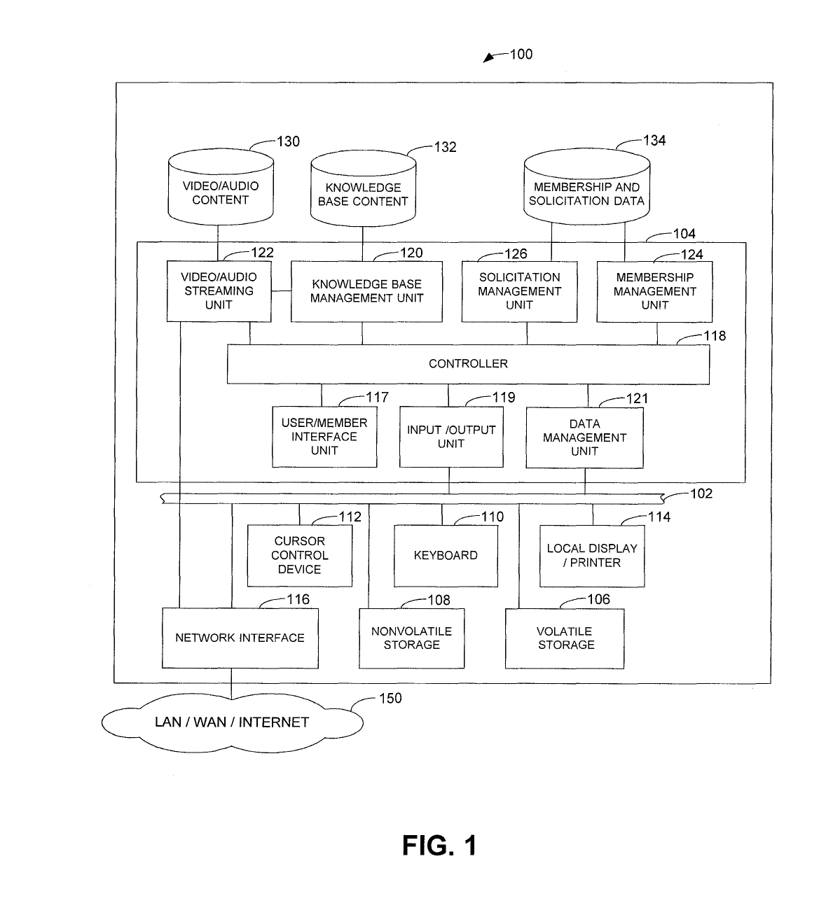

FIG. 1 is a system level block diagram of an exemplary collaborative solicitation apparatus, or collaborative solicitation server 100, that supports the collaborative solicitation of content items, e.g., electronic information products, physical products, actions or services, and the posting of generated content items via a LAN, WAN, and/or Internet connected information source, or knowledge base.

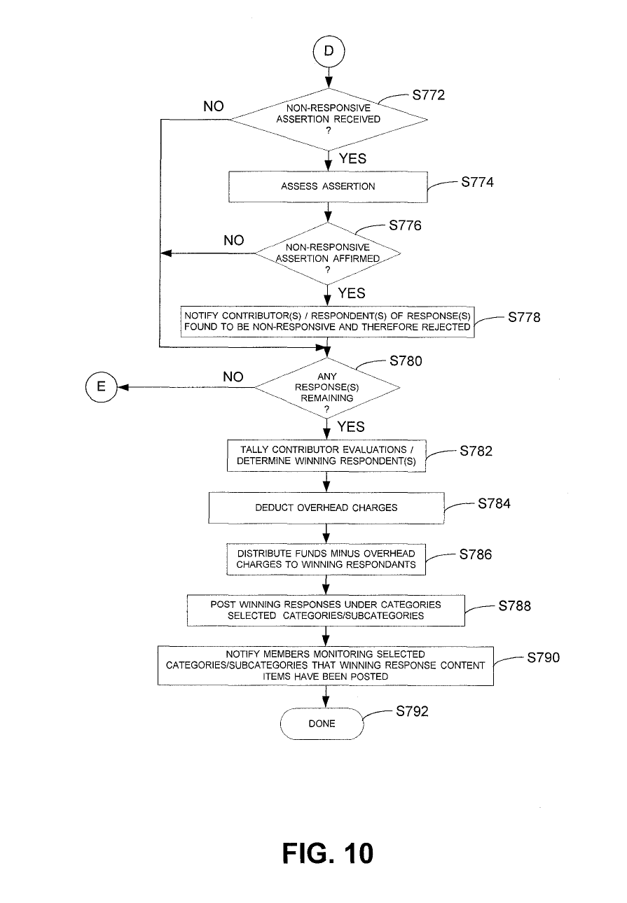

As shown in FIG. 1, a collaborative solicitation server 100 may include a computer system data bus 102 that allows a processor 104 to communicate with, and exchange information with hardware components of the computer such as: volatile storage 106, which allows the processor 104 to store program instructions in local memory for execution and to store and maintain temporary data necessary for execution of the stored program instructions; nonvolatile storage 108, which may store data and program instructions for later retrieval and execution by processor 104; keyboard 110, and/or a cursor control device 112, that allow the processor to receive instructions and/or information from a local operator/administrator of collaborative solicitation server 100; local display/printer 114 which allows processor 104 to format and present reports to a local operator/administrator of collaborative solicitation server 100; and network interface 116 which allows processor 104 to communicate via a LAN, WAN and/or the Internet 150 using one or more communication protocols, e.g., TCP/IP, FTP, HTTP, SMTP, etc., with network connected apparatus, or member stations, participating in a collaborative solicitation and/or searching for and/or accessing knowledge base content items via a user/member interface, such as, for example, the user/member interface described below with respect to FIG. 12 through FIG. 21.

As further shown in FIG. 1, processor 104 may include internal components which allow the processor to communicate with the above-described hardware components to send and receive data and instructions over system bus 102. Such components may include: a controller 118 capable of communicating with and controlling an input/output unit 119 that manages communication exchanges with the system bus 102; and a data management unit 121, which allows the controller to maintain a local set of control parameters such as counters, pointers, and segments of executable program instructions for execution.

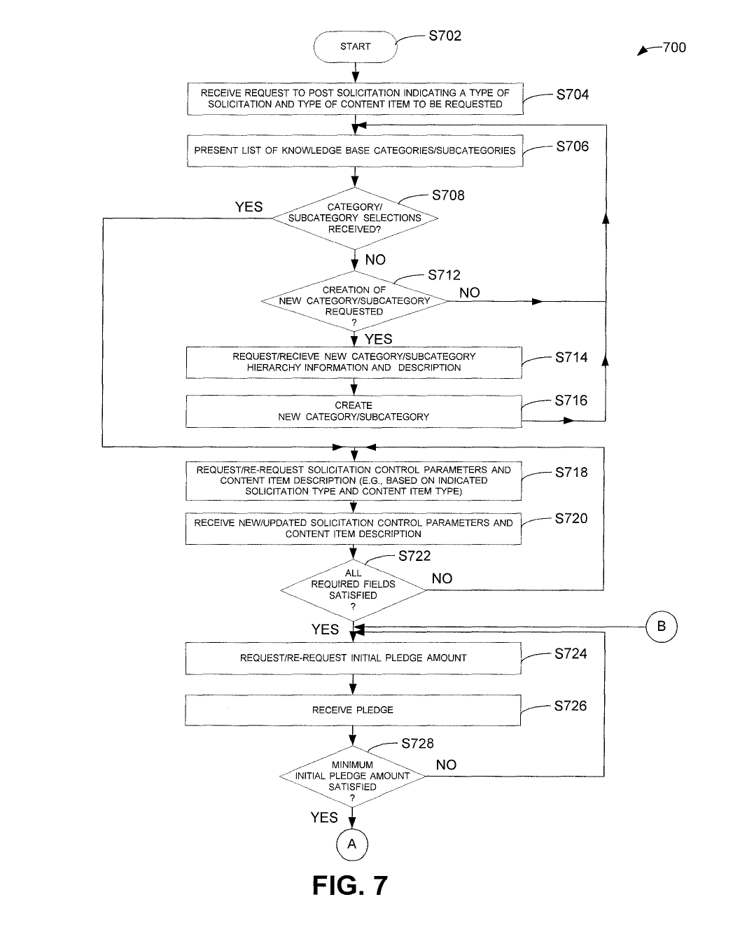

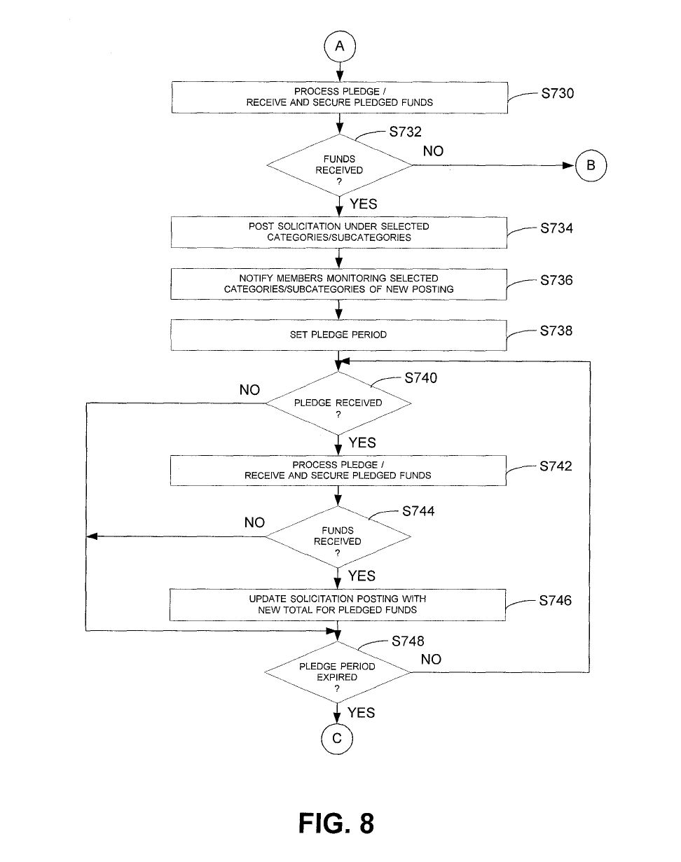

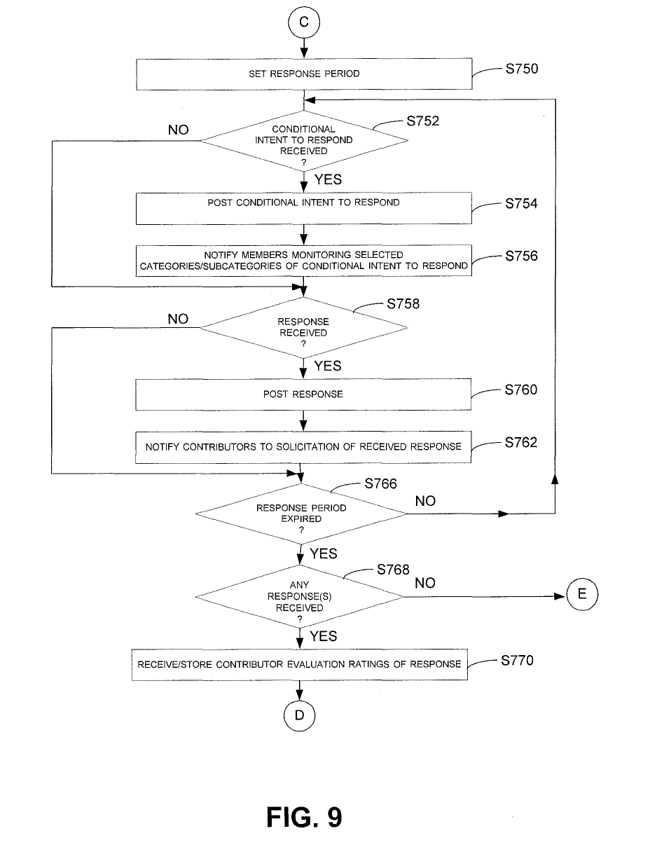

For example, when provided with executable instructions for conducting an exemplary collaborative solicitation for one or more content items, as described below with respect to FIG. 7 through FIG. 11, controller 118, may, in accordance with instructions/commands received from an operator/administrator, retrieve and initiate control parameters/pointers for the execution of program instructions related to managing the collaborative solicitation process. For example, at startup, controller 118 may retrieve and load program instructions from nonvolatile storage 108 into volatile memory 106 for execution and may maintain control parameters in data management unit 121 for use in controlling the simultaneous and/or sequential execution of the program instructions retrieved for execution. In this manner, processor 104 may establish, based on stored program instructions retrieved for execution from nonvolatile storage 108, such as a hard-drive and/or firmware storage: (1) a user/member interface unit 117 that may facilitate exchanges of data between the collaborative solicitation server and member stations operated by members of the user community; (2) a knowledge base management unit 120 that may manage access to and modification of content item descriptions and/or electronic information product content items, e.g., data, text, documents, photographs, video recordings, audio recordings, etc., stored in the knowledge base; (3) a video/audio streaming unit 122 that may manage a store of video and/or audio content items and that is capable of managing the concurrent delivery of multiple outgoing video and/or audio streams from collaborative solicitation server 100 to member stations in response to requests for electronic video/audio content items; (4) a membership management unit 124 that may manage user subscriptions, member validation, validation of member content item searches and/or content item requests and/or may generate outgoing notifications to member stations; and (5) a solicitation management unit 126 that may manage process flows associated with multiple concurrent content item solicitations, as described below with respect to FIG. 7 through FIG. 11. Controller 118 may receive and process data extracted from communications with member stations by user/member interface unit 117 and may control the execution of actions performed by each of the respective units described above in accordance with process flows controlled by controller 118. Further, with support from user/member interface unit 117, e.g., in performing user interface formatting, data insertion and data extraction activities, controller 118 may control exchanges of data between collaboration server 100 and the respective member stations via a user interface that may allow member stations to communicate with the collaborative solicitation controller via an interactive, visual display based user interface, such as the exemplary user interface described below with respect to FIG. 12 through FIG. 21.

As further shown in FIG. 1, knowledge base management unit 120, video/audio streaming unit 122, membership management unit 124, and solicitation management unit 126 may each maintain data stores that contain data necessary to store and manage data related to their respective functions. For example, as shown in FIG. 1, knowledge base management unit 120 may maintain a knowledge base content data store 132, video/audio streaming unit 122 may maintain a video/audio content data store 130, and membership management unit 124 and solicitation management unit 126 may share a membership and solicitation data store 134.

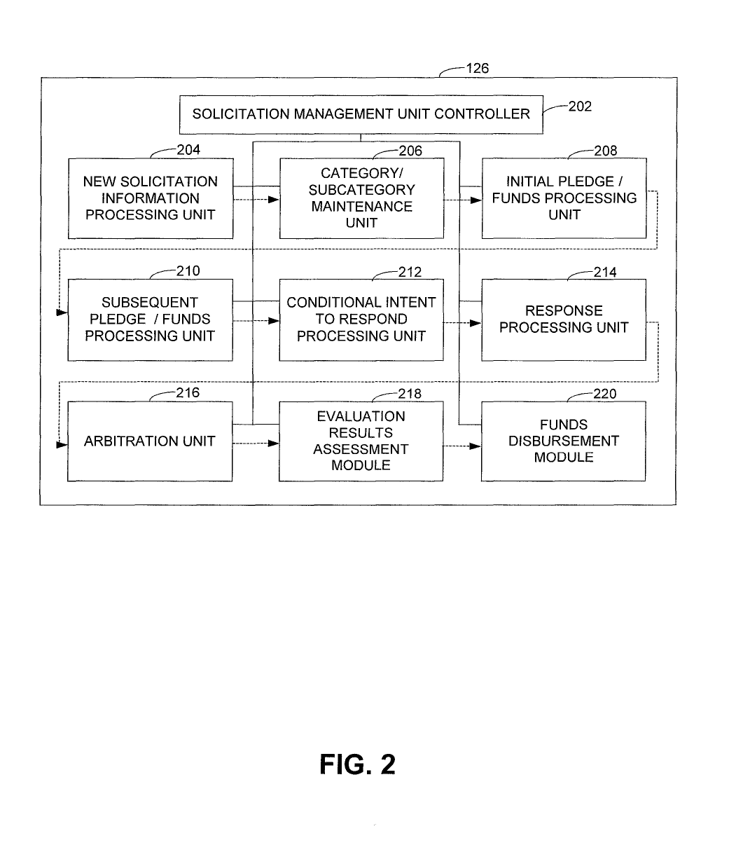

FIG. 2 is a block diagram of an exemplary solicitation management unit 126 within the exemplary collaborative solicitation server 100 shown in FIG. 1. As shown in FIG. 2, exemplary solicitation management unit 126 may include a solicitation management unit controller 202, new solicitation information processing unit 204, category/subcategory maintenance unit 206, initial pledge/funds processing unit 208, subsequent pledge/funds processing unit 210, conditional intent to respond processing unit 212, response processing unit 214, arbitration unit 216, evaluation results assessment module 218, and funds disbursement module 220, as described in greater detail below. As further shown in FIG. 2 with a solid line connecting the respective units, each of the units associated with solicitation management unit 126 may communicate with each other and with solicitation management unit controller 202. The dashed line between the connecting the respective units represents an exemplary flow of processing performed by each of the respective units in support of a single exemplary content item solicitation process, for example, as described below with respect to FIG. 7 through FIG. 11.

In one exemplary embodiment, solicitation management unit controller 202 may receive and process information and instructions received from controller 118 related to one or more concurrent content item solicitations and may initiate action by providing commands and data to one or more of the units introduced above, based on, for example, status parameters and data stored by solicitation management unit controller 202 for each active content item solicitation.

New solicitation information processing unit 204 may support processing related to handling a request for a new content item solicitation. Features performed may include verifying the identity of the requester, e.g., via membership management module 124, and initiating a new solicitation record and interfacing with a user to obtain a complete and accurate description of the content item being solicited. For example, in one embodiment, on receipt of a solicitation request identifying a type content item that is to be solicited, new solicitation information processing unit 204may forward to the soliciting member station a request for information items that may be used to fully describe the content item to be produced and/or to define rules and/or conditions that are to be used to govern the solicitation process.

For example, in one exemplary embodiment, new solicitation information processing unit 204 may allow a soliciting member station to define the solicitation as one of several solicitation types, which may include but are not limited to: a private solicitation; a group solicitation; an open solicitation; a charitable solicitation; and a reverse solicitation.

If a solicitation is defined as a private solicitation, only the soliciting member, i.e., the user creating the solicitation, may contribute funds to the solicitation and only the soliciting member may review the responses received. In a private solicitation, the collaborative solicitation server may act as a broker that allows a single individual to locate individuals willing to provide a content item that meets a specific information, service or product need of the user, once the soliciting member has contributed a sum to the solicitation that sufficiently economically motivates a potential respondent to produce and to provide the desired product or service.

If a solicitation is defined as a group solicitation, only the soliciting member and members of an identified group of members may contribute funds to the solicitation and control the review of responses received. In a group solicitation, the collaborative solicitation server may act as a broker that allows a group of individuals to contribute to the solicitation and to locate individuals willing to provide a content item that meets a specific information, service or product need of the members of the group, once the identified group of contributing members have contributed a sum to the solicitation that sufficiently economically motivates a potential respondent to produce and to provide the desired product or service. For example, in a group solicitation, the soliciting member may provide an invitee list that may include an email address for each individual allowed to contribute to the solicitation. The solicitation server may generate and send an email with information about the solicitation to each email address in the invitee list, inviting each of the respective invitees to participate in the solicitation.

If a solicitation is defined as an open solicitation, any member with access to the collaborative solicitation server may contribute to the solicitation and provide feedback with respect to the received responses. In an open solicitation, the collaborative solicitation server may act as a broker that allows any member with access to the collaboration server to contribute to the solicitation and to locate individuals willing to provide a content item that meets a specific information, service or product need of the contributing members, once the contributing members have contributed a sum to the solicitation that sufficiently economically motivates a potential respondent to produce and to provide the desired product or service.

If a solicitation is defined as a charitable solicitation, any member with access to the collaborative solicitation server may contribute to the solicitation and provide feedback with respect to the received responses. In a charitable solicitation, the collaborative solicitation server may act as a broker that allows any member with access to the collaboration server to contribute to the solicitation and to locate individuals willing to provide a content item that meets a specific information, service or product need of the contributing members once the contributing members have contributed a sum to a designated charity that sufficiently economically motivates a potential respondent to produce and to provide the desired product or service. For example, the soliciting member may initiate a solicitation, but may designate a recognized charity as the beneficiary of the solicitation. Members would be encouraged to contribute to the solicitation and potential respondents would be encouraged to produce content for the benefit of the recognized charity.

If a solicitation is defined as a reverse solicitation, the soliciting member may serve as a sole respondent who offers to provide a product or service described in the reverse solicitation, if the total sum of contributions by contributing members reaches a predetermined minimum. The reverse solicitation may designate the soliciting member as the recipient of the contributed funds, or may designate one or more other individuals, organizations and/or private or charitable groups as the recipient of the contributed funds. In a reverse solicitation, the collaborative solicitation server may act as a broker that allows a content provider to locate individuals willing to contribute funds that sufficiently economically motivates the soliciting member/respondent to produce and to provide the desired product and/or service.

Please note that use of an invitee list is not limited to use with a group solicitation. An invitee list may also be used in association with an open solicitation, a charitable solicitation, and/or a reverse solicitation; however, the potential contributing members is not limited to those members identified in the invitee list, as described above with respect to the group solicitation.

In addition to allowing a soliciting member to designate the type of solicitation, new solicitation information processing unit 204 may also allow the soliciting member to designate one or more additional parameters that may be used to control execution of the solicitation. For example, the soliciting member may set one or more of: a minimum contribution amount; a time frame for the contribution period, e.g., 30 to 120 days prior to the response period and/or concurrent with the response period; a time frame for the response period, e.g., 30 to 365 days; a time frame for the review/rating period, e.g., concurrent with the response period and/or 1 to 7 days following the end of the response period, whether the soliciting member will accept basic communication on pricing from potential content providers; whether the solicitation will accept conditional intent to respond minimum bids from potential respondents, the minimum bid being displayed in conjunction with the solicitation thus indicating to the soliciting member and potential contributing members a minimum price for which a potential respondent would consider responding to the solicitation with a content item; whether the response period is to be closed to further respondents on receipt of a response that promises delivery of a content item and that is accepted by the soliciting member; whether the response(s) received will be evaluated by all contributing members, by the soliciting member himself, or by some other group/organization identified by the soliciting member; whether the soliciting member will charge no fee, a fixed fee, or a percentage of contributions, in compensation for preparing and initiating the solicitation; the arbitration panel to be used in case a controversy arises during the solicitation process; and/or any other parameter which may be used to control operation of the solicitation.

Category/subcategory maintenance unit 206 may provide a solicitation member station with an opportunity to select one or more categories/subcategories under which the solicitation should be posted and/or may allow the soliciting member station, e.g., via coordination with knowledge base management unit 120, to create a new category and/or subcategory under which the solicitation may be posted within the knowledge base for access via the LAN/WAN Internet by member stations.

Initial pledge/funds processing unit 208 may receive an initial pledge by a solicitation requester, and verify that the funds pledged meet a minimum threshold based on, for example, the number of knowledge base categories/subcategories within which the solicitation requester wishes to post the solicitation. If the minimum threshold is met, initial pledge/funds processing unit 208 may attempt to execute a transfer of funds using a selected mode of electronic payment, e.g., credit card, debit note, etc., and if the transfer of funds is complete, may finalize the new solicitation and may instruct knowledge base management unit 120 to post the new solicitation. Further, once the new solicitation is posted initial pledge/funds processing unit 208 may instruct the membership management unit 124 to notify members monitoring the respective categories/subcategories to which the solicitation has been posted that a solicitation relevant to their area of interest/expertise has been posted and is ready for their review.

Subsequent pledge/funds processing unit 210 may process requests from contributing members who wish to pledge additional funds to the posted solicitation. If a subsequent pledge meets a minimum subsequent pledge threshold, subsequent pledge/funds processing unit 210 may attempt to execute a transfer of funds using a mode of payment, e.g., credit card, debit note, etc., and if the transfer of funds is complete, may instruct knowledge base management unit 120 to update the summed total value of pledged funds, or total pledged sum, associated with the posted solicitation.

Conditional intent to respond processing unit 212 may receive correspondence from a conditional respondent to the solicitation, may validate the member's identity via membership management module 124, and may forward the correspondence to knowledge base management unit 120 for inclusion in the posted solicitation. For example, a conditional respondent may reply stating that he intends to submit a response if a threshold pledge value is reached, thereby providing additional motivation to existing solicitation contributors to increase their respective pledges and/or to encourage like-minded members to place a pledge.

Response processing unit 214, may process a received response, e.g., a photo, a video recording, an audio recording, drawings, a promise to provide a product or service, etc., verify the identity of the member submitting the response, and may coordinate with knowledge base management unit 120 to post the response in the knowledge base in association with the solicitation that the response is intended to satisfy. Further, response processing unit 214 may instruct the membership management unit 124 to notify contributing members, i.e., members who have contributed funds to the solicitation that the response is intended to satisfy, to inform them that a response has been received and is ready for their review. In one exemplary embodiment, contributing members may be allowed to access the posted content items, or response items, received in response to a solicitation to which they contributed, and may be allowed to rate the content item with respect to such factors as: a level of responsiveness to the solicitation, e.g., by assigning an evaluation value from 1 to 5, in which 5 is very responsive and 1 is not very responsive; quality of the content item, e.g., by assigning an evaluation value from 1 to 5, in which 5 is very response and 1 is not very responsive; and or any other evaluation criteria that may be appropriate based on the nature of the item submitted. Such evaluation criteria may be defined by a soliciting member station when coordinating with new solicitation processing unit 204 to define content items and control parameters associated with a solicitation, as described above.

Arbitration unit 216 may be invoked if one of the contributing members reviewing a response asserts that a posted response does not satisfy the posted solicitation content item requirements. For example, a member may submit a video recording related to changing the transmission on a Ford Model T automobile, whereas the solicitation explicitly requires a video recording related to replacing a main bearing on a Ford Model 8N tractor. If an assertion of non-responsiveness is received, an official arbitrator overseeing the solicitation may review the submitted response item and may issue a final decision regarding the responsiveness of the response item. If the arbitrator decides that the received response item is non-responsive, the response item may be disqualified from the posted solicitation, and the member that submitted the non-responsive response item may be notified of the arbitrator's final decision.

Further, arbitration unit 216 may be invoked by a soliciting member to assert dilution of a solicitation. For example, an arbitrator may decide that a subsequent solicitation unfairly dilutes an initial solicitation if the subsequent solicitation is posted after the initial solicitation and the content item requested in the subsequent solicitation is substantially identical to the content item requested in the initial solicitation. Such a subsequent solicitation would tend to unfairly reduce the total sum of contributions received by the initial solicitation, and may thereby dilute the effectiveness of the collaborative solicitation server in attracting respondents, and/or reduce the fee awarded to the soliciting member who initiated the initial solicitation, and/or reduce an amount awarded to an entity designated by the initial solicitation to received the summed contributions of the solicitation. The arbitrator may terminate any subsequent solicitation found to dilute an initial solicitation and may return to the respective contributing members any funds contributed to a revoked subsequent solicitation.

Evaluation results assessment module 218, may be invoked once a contributing member review period, in which contributing members may be allowed to access and evaluate posted content items received in response to a solicitation, as described above, has expired. The evaluation results assessment module 218 may assess the received evaluation information and may select, for example, a first place winner, a second place winner, and a third place winner, based on the evaluation data received from contributing members and in accordance with criteria specified in the solicitation.

Funds disbursement module 220 may be invoked, for example, once the first, second, and/or third place winners have been identified, and may distribute the pledged funds to the winners based on their respective showing. For example, after a pre-determined, and/or percentage based administrative fee is deducted from the total of pledged funds, the remaining funds may be disburse in a manner such as: the first place winner may receive 70% of the remaining funds; the second place winner may receive 20% of the remaining funds, and the third place winner may receive 10% of the remaining funds, or the funds may be distributed in some other manner in accordance with criteria specified in the solicitation.

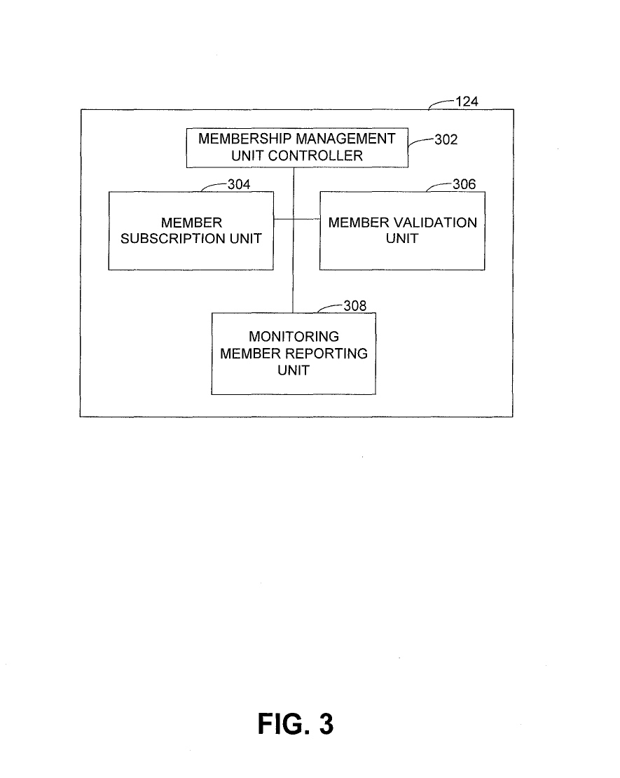

FIG. 3 is a block diagram of an exemplary membership management unit 124 within the collaborative solicitation server 100 shown in FIG. 1. As shown in FIG. 3, exemplary membership management unit 124 may include a membership management unit controller 302, a member subscription unit 304, a member validation unit 306, and a monitoring member reporting unit 308, as described in greater detail below.

In one exemplary embodiment, membership management unit controller 302 may receive and process information and instructions received from controller 118 related to the creation, management and control of member accounts. For example, membership management unit controller 302 may provide collaborative solicitation server 100 with the ability to collect and protect member data, validate a member's identity, verify the authority of users requesting access to the knowledge base, and/or control the transmission of reports to a member based on options selected by a member, by coordinating operation of member subscription unit 304, a member validation unit 306, and a monitoring member reporting unit 308 based on, for example, status parameters and data stored by membership management unit controller 302. Such capabilities may be used throughout processes supported by collaborative solicitation server 100.

For example, member subscription unit 304 may be responsible for issuing usernames and passwords to prospective members. In one exemplary embodiment, member subscription unit 304 may solicit information such as name, mailing address, email address, occupation, etc. before granting the user a membership username and password that entitles the user to search the knowledge base for content items or before being allowed to search outstanding solicitations. Member subscription unit 304 may require a higher level of authentication, e.g., a valid credit card, before the member's username/password combination is allowed to pledge a contribution to a solicitation.

Member validation unit 306 may be responsible for challenging a user for his member username/password prior to gaining access to the knowledge base after a predetermined period of time has elapsed. Member validation unit 306 may be responsible for challenging a user for his member username/password prior to allowing a member to perform an action such as accessing adult-oriented materials, and/or before pledging a contribution to a solicitation. In this manner, member validation unit 306, may enforce safeguards that ensure that only authorized users gain access to the various services and content items accessible via collaborative solicitation server 100.

Monitoring member reporting unit 308 may maintain, in association with a valid member username, a set of categories/subcategories with which a member has a continued interest. For example, a member may, at any time access information related to his membership account and may update personal information contained within. For example, a member may select from a list of available categories/subcategories associated with the knowledge base, a set of categories/subcategories that the member is interested in monitoring. The member may request to be automatically notified, e.g., by email, each time a content item, solicitation and/or response is added to the knowledge base in association with one or more of the categories/subcategories that the member wishes to monitor. Further, a member may request to be notified prior to expiration of a response review period for a solicitation to which the member has made a contribution.

In one exemplary embodiment, monitoring member reporting unit 308 may communicate with knowledge base management unit 120 and solicitation management unit 126 and may track categories/subcategories in which a member has recently and/or frequently shown an interest, based on one or more activities, such as content items and/or solicitations that the member has browsed and/or queries used by the member to search the knowledge base for content items/solicitations. Monitoring member reporting unit 308 may store such automatically collected category/subcategory information in association with the member's membership data. The member may be automatically notified, e.g., by email, each time a content item, solicitation and/or response is added to the knowledge base in association with one or more of the categories/subcategories in which the member has expressed an interest.

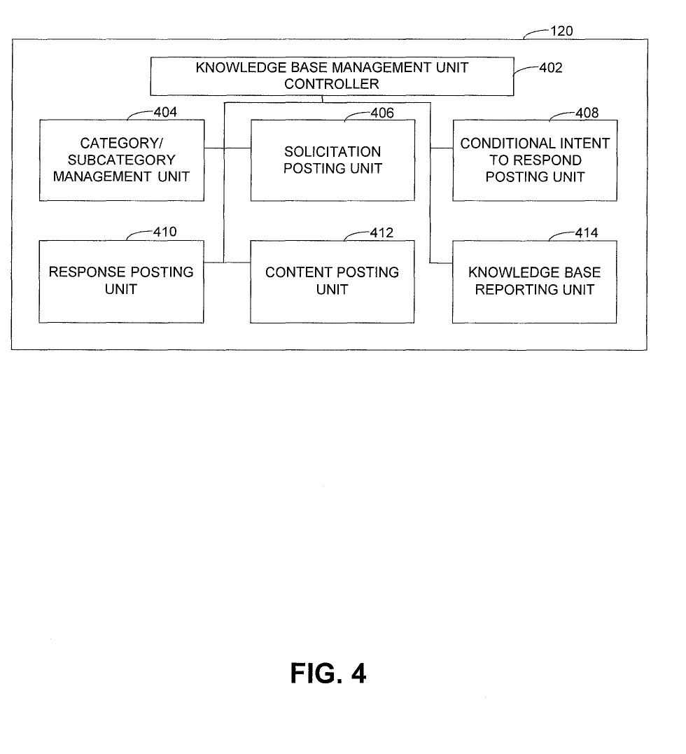

FIG. 4 is a block diagram of an exemplary knowledge base management unit 120 within the collaborative solicitation server 100 shown in FIG. 1. As shown in FIG. 4, exemplary knowledge base management unit 120 may include a knowledge base management unit controller 402, a category/subcategory management unit 404, a solicitation posting unit 406, a conditional intent to respond posting unit 408, a response posting unit 410, a content posting unit 412, and a knowledge base reporting unit 414, as described in greater detail below.

In one exemplary embodiment, knowledge base management unit controller 402 may provide collaborative solicitation server 100 with the ability to manage access to and manage content of knowledge base content 132 (shown in FIG. 1), which may include, but is not limited to, posted content items, posted solicitations, conditional intent to respond postings, and posted responses to pending solicitations. As described above, knowledge base content may further include one or more hierarchical views of the stored information and may support keyword searching, metadata based searching, and or any other approach for facilitating efficient search and retrieval of information relevant to a member's information needs. Knowledge base management unit controller 402 may provide such capability by invoking, as needed, capabilities provided by the units described below.

Category/subcategory management unit 404 may be responsible for maintaining, for example, a variety of hierarchical views to the content items, pending solicitations and responses posted to the database. For example, information within the knowledge base may be organized by category/subcategory views, based on metadata associated with an information item and/or a category/subcategory that has been manually assigned to the information item. Information may be further organized, based on the organization, e.g., university, research group, etc., that originated the information. In addition, other hierarchical groupings may be supported. For example, pending solicitations may be organized based on country/region of origin, and/or other basis. Category/subcategory management unit 404 may allow a system administrator to define new hierarchical views and/or to manage existing hierarchical views. Further, in coordination with the solicitation management unit 126, category/subcategory management unit 404 may allow a member posting a new solicitation to add a new category and/or subcategory, thereby allowing the member to assign to solicitation to one or more categories/subcategories that the member feels appropriately characterize the nature of the solicitation, as described above.

Solicitation posting unit 406 may allow new solicitations generated by solicitation management unit 126, as described above, to be posted to the knowledge base for review by members.

Conditional intent to respond posting unit 408 may allow a conditional intent to respond received by solicitation management unit 126, as described above, to be posted to the knowledge base in association with a pending solicitation.

Response posting unit 410 may allow a response to a pending solicitation received by solicitation management unit 126, as described above, to be posted to the knowledge base in association with the pending solicitation.

Content posting unit 412 may allow a content item received as a result of a solicitation process, as described above, to be posted to the knowledge base in association with one or more hierarchical views so that the content item is accessible by members authorized to access the content item.

Knowledge base reporting unit 414 may process a search query, an explicit request for a content item, or a request for a solicitation related item, received from a member station and may generate a response for transmission to the requesting member station. Further, knowledge base reporting unit 414 may generate notification reports after a new solicitation is posted to the knowledge base, or after a new solicitation response or content item is posted to the knowledge base. Such reports may be distributed, by membership management unit 124 as described above, to members monitoring the categories/subcategories with which the new information is associated.

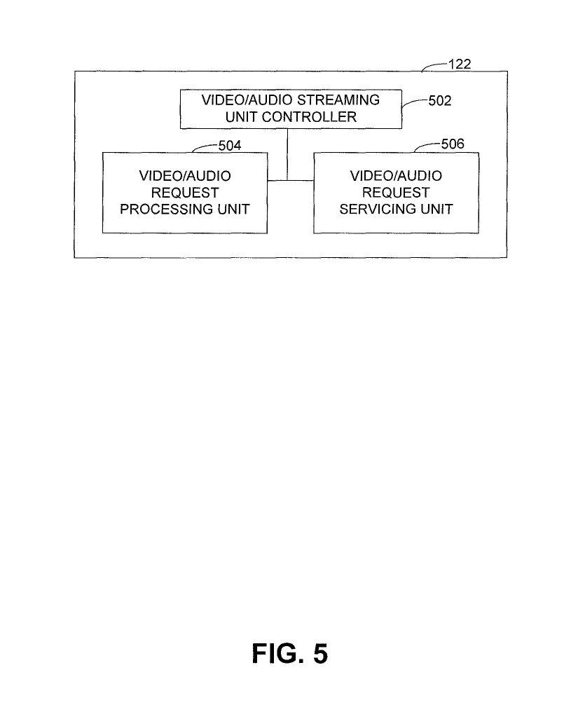

FIG. 5 is a block diagram of exemplary video/audio streaming unit 122 within the collaborative solicitation server 100 shown in FIG. 1. As shown in FIG. 5, exemplary video/audio streaming unit 122 may include a video/audio streaming unit controller 502, a video/audio request processing unit 504 and a video/audio request servicing unit 506, as described in greater detail below.

In one exemplary embodiment, video/audio streaming unit controller 502 may coordinate with controller 118 to provide collaborative solicitation server 100 with the ability to store and manage large content items, such as video recording and/or audio recording content items. Further, video/audio streaming unit 122, may support service requests from knowledge base management unit 120 to provide a streaming video or streaming audio content file in response to a request for the respective items by one or more member stations.

For example, on receiving a request from knowledge base management unit 120 to deliver a specified video or audio stream, video/audio streaming unit controller 502 may pass the request to video/audio request processing unit 504. After validating via membership management unit 124 that the indicated member is authorized to view the requested video and/or audio content item, video/audio request processing unit 504 may initiate a streaming video or streaming audio process and may pass control of the video/audio streaming process to video/audio request servicing unit 506. Video/audio request servicing unit 506 may then manage delivery of the streaming audio and/or video to the indicated member, thereby freeing video/audio request processing unit 504 to respond to a next request for an audio and/or video content item. In this manner video/audio streaming unit 122 may be able to initiate an manage concurrent delivery of numerous, e.g., hundreds, or even thousands, audio and/or video content items to members without reducing the capacity of the knowledge base management unit 120, solicitation management unit 126 and/or membership management unit 124.

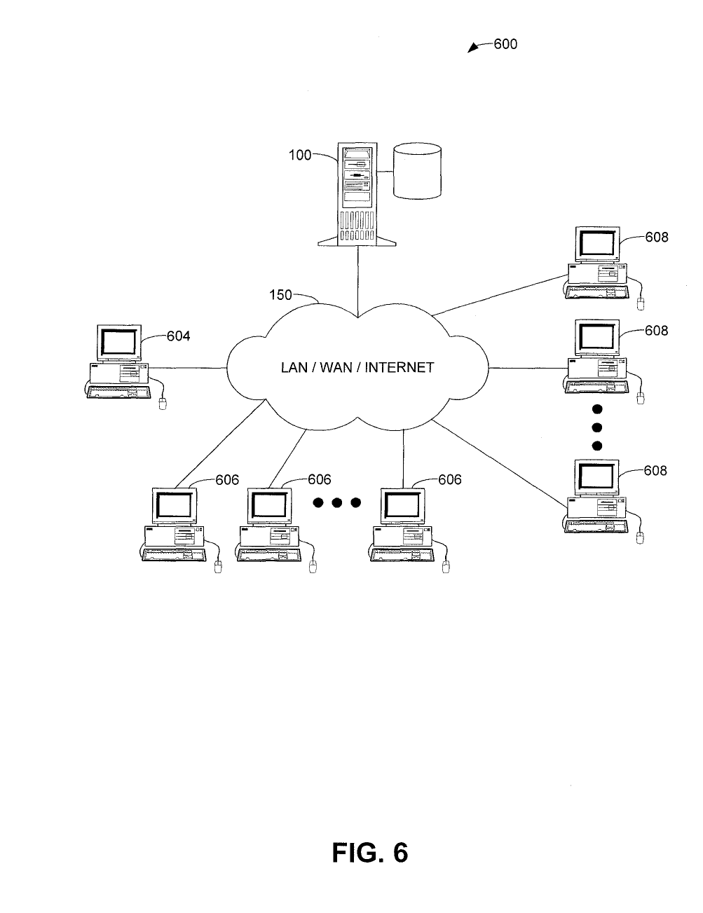

FIG. 6 is a schematic diagram of an exemplary LAN, WAN and/or Internet based network 600 that provides connectivity between a collaborative solicitation server 100 and member stations, as described above with respect to FIG. 1. As shown in FIG. 6, a soliciting member station 604 may communicate with collaborative solicitation server 100 to initiate a solicitation for a content item described in the solicitation. Once the solicitation has been posted to the knowledge base, one or more contributing member stations 606 may become aware of the solicitation, e.g., by parsing the knowledge base and locating the posted solicitation and/or by being automatically notified of the posted solicitation as a result of monitoring a category/subcategory under which the solicitation has been posted, and may pledge a contribution to the solicitation. In addition, one or more responding member stations 608 may become aware of the solicitation, and may monitor the solicitation until the pledged amount reaches a threshold at which the user operating each of the respective responding station is motivated to locate and/or generate the requested content item and to submit the content item to collaborative solicitation server 100 as a timely response to a pending solicitation.

In the description provided above with respect to FIG. 6, any member station connected to collaborative solicitation server 100 via a LAN, WAN and/or Internet 150 may serve as one or more of a soliciting member station 604, contributing member stations 606, and responding member stations 608. Such designations are used in the description above with respect to FIG. 6 to designate functions performed by the respective member stations, and are not intended to imply any specific differences in the hardware or software features or capabilities the respective stations. Further the functions performed by the respective member stations are actually the result of actions taken by users operating the respective stations that have been logged in to collaborative solicitation server 100 using, for example, a username password via, for example, a user interface such as the exemplary user interface described below with respect to FIG. 12 to FIG. 21.

FIG. 7, FIG. 8, FIG. 9, FIG. 10 and FIG. 11 present a flow diagram of an exemplary process 700 that may be executed by a collaborative solicitation server 100 to execute an exemplary collaborative solicitation process.

As shown in FIG. 7, the described process begins at step S702 and proceeds to step S704.

In step S704, collaborative solicitation server 100 may receive a new solicitation request from a member station. Such an initial solicitation request may include a type of solicitation, e.g., individual, group, open, charitable, reverse, etc., and a type of content item to be requested, e.g., a video recording, a photograph, an audio clip, a reference document, a service or act to be performed, etc. Once the new solicitation request has been received by the collaborative solicitation server, operation of the method may continue to step S706.

In step S706, collaborative solicitation server 100 may present the soliciting member station with a list of knowledge base categories and subcategories that the soliciting member station may select for association with the solicitation. For example, if the solicitation is for a video recording on how to rebuild a Ford Model 8N tractor, the solicitation may be associated with categories such as farm equipment or collectables or heavy machinery, and subcategories such as tractors, farm equipment and Ford, respectively. Once one or more categories/subcategories have been presented to the soliciting member, operation of the method may continue to step S708.

In step S708, if the collaborative solicitation server receives category/subcategory selections from the soliciting member station, the method may continue to step S718, otherwise, the method may continue to step S712.

If, in step S712, the collaborative solicitation server receives a request from the soliciting member station to create one or more new categories/subcategories, the method may continue to step S714, otherwise, the method returns to step S706.

In step S714, the collaborative solicitation server may request and receive from the soliciting member station information required to create a new category/subcategory, such as a name and description of one or more requested new categories and/or subcategories and their relative location in an existing hierarchy, and operation of the method may continue to step S716.

In step S716, the collaborative solicitation server may create a new category and/or subcategory based on the information received, and operation of the method may continue to step S706.

In step S718, the collaborative solicitation server may request a detailed description of the content item associated with the new solicitation and may request detailed solicitation control parameters, e.g., a minimum contribution amount, a time frame for the contribution period, a time frame for the response period, etc. The information request may be based, in part, on the type of solicitation and the type of content item designated by the soliciting member station in step 704 and the categories/subcategories that have been associated with the solicitation request. Once a request for content item descriptive information is sent to the soliciting member station, operation of the method may continue to step S720.

In step S720, the collaborative solicitation server may receive from the soliciting member station detailed solicitation control parameters and a detailed description of the content item associated with the new solicitation, and operation of the method may continue to step S722.

In step S722, if the collaborative solicitation server determines that all required solicitation control fields and content item description fields received from the soliciting member station have been completed, operation of the method may continue to step S724, otherwise, operation of the method may return to step S718.

In step S724, the collaborative solicitation server may request an initial pledge amount from the soliciting member station, and operation of the method may continue to step S726.

In step S726, the collaborative solicitation server may receive an initial pledge amount from the soliciting member station, and operation of the method may continue to step S728.

If, in step S728, the collaborative solicitation server determines that the initial pledge satisfies an minimum allowed pledge, operation of the method may continue to step S730, otherwise, operation of the method may return to step S724.

In step S730, the collaborative solicitation server may process the received pledge in an attempt to receive and process the pledged funds, and operation of the method may continue to step S732.

If, in step S732, the collaborative solicitation server determines that the pledged funds have been successfully received and secured, operation of the method may continue to step S734, otherwise, operation of the method may return to step S724.

In step S734, the collaborative solicitation server may post the solicitation within the knowledge base in association with the categories/subcategories selected by the soliciting member station, and operation of the method may continue to step S736.

In step S736, the collaborative solicitation server may notify member stations monitoring the categories/subcategories associated with the newly posted solicitation of the new solicitation posting, and operation of the method may continue to step S738.

In step S738, the collaborative solicitation server may set a solicitation pledge period based on a configurable solicitation control parameter provided by the soliciting member station, e.g., one month, during which the solicitation may remain open for receiving pledges from contributing member stations, and operation of the method may continue to step S740.

If, in step S740, the collaborative solicitation server determines that a pledge has been received, operation of the method may continue to step S742, otherwise, operation of the method may continue to step S748.

In step S742, the collaborative solicitation server may process the received pledge in an attempt to receive and process the pledged funds, and operation of the method may continue to step S744.

If, in step S744, the collaborative solicitation server determines that the pledged funds have been successfully received and secured, operation of the method may continue to step S746, otherwise, operation of the method may continue to step S748.

In step S746, the collaborative solicitation server may update the corresponding solicitation posted within the knowledge base with an updated pledged fund total, or total pledged sum, that includes the newly received pledge, and operation of the method may continue to step S748.

If, in step S748, the collaborative solicitation server determines that the pledged period has expired, operation of the method may continue to step S750, otherwise, operation of the method may return to step S740.

In step S750, the collaborative solicitation server may set a solicitation response period based on a configurable solicitation control parameter provided by the soliciting member station, e.g., two months, during which the solicitation may remain open for receiving both responses to the pending solicitation containing submitted content items and/or conditional intent to respond responses, and operation of the method may continue to step S752.

If, in step S752, the collaborative solicitation server determines that a conditional intent to respond has been received, operation of the method may continue to step S754, otherwise, operation of the method may continue to step S758.

In step S754, the collaborative solicitation server may process the received conditional intent to respond to verify the identity of the member making the conditional intent to respond and to retrieve and post to the pending solicitation the conditions associated with the conditional intent to respond. For example, a conditional intent to respond may indicate that the respondent intends to submit a response if the pledged funds meet a certain minimum level and/or the conditional intent to respond may state that any funds distributed to the respondent are to be redirected to one or more identified charities. Once the conditions of the conditional intent to respond are posted to the pending solicitation, operation of the method may continue to step S756.

In step S756, the collaborative solicitation server may notify contributing members and members monitoring the categories/subcategories associated with the pending solicitation that a conditional intent to respond has been received, and operation of the method may continue to step S758.

If, in step S758, the collaborative solicitation server determines that a response has been received, operation of the method may continue to step S760, otherwise, operation of the method may continue to step S766.

In step S760, the collaborative solicitation server may process the received response to verify the identity of the member submitting the response and to retrieve the one or more content items associated with the response. Once the identity of the member submitting the response is verified, and the one or more content items associated with the response are retrieved, the content items may be posted to the online knowledge base in association with the pending solicitation. Once the response content items and/or other response related information is posted to the knowledge base in association with the related pending solicitation to which the response replies, operation of the method may continue to step S762.

In step S762, the collaborative solicitation server may notify contributing members and members monitoring the categories/subcategories associated with the pending solicitation that a response has been received, and operation of the method may continue to step S766.

If, in step S766, the collaborative solicitation server determines that the response period has expired, operation of the method may continue to step S768, otherwise, operation of the method may return to step S752.

If, in step S768, the collaborative solicitation server determines that no responses have been received, operation of the method may continue to step S794, otherwise, operation of the method may continue to step S770.

In step S770, the collaborative solicitation server may receive and store for later assessment, ratings and/or evaluations of the submitted response content items from reviewing members. For example, in one exemplary embodiment, the members allowed to view a response content item during the response period may be limited to only contributing members who have pledged contributions to the solicitation to which the response content item applies. In this manner, the review is more likely to receive serious reviews by individual with a vested interest in the responsiveness and quality of the submitted content item. Members may be provided a period of time, e.g. 1 week, 2 weeks, after expiration of the response period to review the content items associated with the solicitation and submit their evaluation ratings. Any contributing member who does not evaluate and submit ratings within the allowed time period may be considered to have forfeited his opportunity to contribute to the evaluation of the responses. Once the evaluation period for reviewing responses has expired, operation of the method may continue to step S772.

If, in step S772, the collaborative solicitation server determines that an assertion of non-responsiveness has been asserted by one or more of the evaluating members against one or more of the response content items, operation of the method may continue to step S774, otherwise, operation of the method may continue to step S780.

In step S774, and arbitrator may review the response content items that have been asserted to be non-responsive, and operation of the method may continue to step S776.

If, in step S776, the arbitrator affirms that one or more of the response content items is non-responsive to the requirements of the solicitation, operation of the method may continue to step S778, otherwise, operation of the method may continue to step S780.

In step S778, the arbitrator may notify the contributing members and respondents that a response content item has been found to be non-responsive and has been rejected from the solicitation. In one exemplary embodiment, such a decision is final and no opportunity is provided to the responding member to contest the arbitrator's decision, in other exemplary embodiments, however, the responding member who submitted the rejected response may submit a request for reconsideration along with reasons why the arbitrator's initial decision is in error. However, once a final decision is made by the arbitrator, the decision of the arbitrator, based on terms of use accepted by all members prior to participation in the solicitation, may be considered final. Once a final decision is reached by the arbitrator and contributing members and responding members are informed of the arbitrators decision, operation of the method may continue to step S780.

If, in step S780, the collaborative solicitation server determines that one or more responses to the solicitation remain associated with the solicitation, operation of the method may continue to step S782, otherwise, operation of the method may continue to step S794.

In step S782, the collaborative solicitation server may tally the evaluation ratings submitted by evaluating members and may determine the one or more winning respondents, and operation of the method may continue to step S784.

In step S784, the collaborative solicitation server may deduct overhead charges for conducting the solicitation, and operation of the method may continue to step S786.

In step S786, the collaborative solicitation server may electronically distribute the contributed funds, minus the deducted overhead charges, to the winning respondents. For example, the respondent receiving the highest combined rating may receive 70% of the remaining contributed funds, the respondent receiving the second highest combined rating may receive 20% of the remaining contributed funds, the respondent receiving the third highest combined rating may receive 10% of the remaining contributed funds, and other respondents may be awarded trivial prizes, e.g., T-shirts, or nothing. Once funds have been distributed to the winning respondents, operation of the method may continue to step S788.

In step S788, the collaborative solicitation server may, e.g., based on solicitation control parameters controlling the disposition of solicitation content items, post content items associated with the solicitation to the knowledge base in association with the categories/subcategories associated with the solicitation, and operation of the method may continue to step S790.

In step S790, the collaborative solicitation server may notify contributing members and members monitoring the categories/subcategories associated with the solicitation that the winning response content items have been posted to member accessible knowledge base, and that the solicitation has been successfully completed. Operation of the method may continue to step S792 and may terminate.

As described in the above process at step S768 and step S780, if no responses are received within a solicitation's response period, as described at step S768, or if no responses remain after one or more responses have been disqualified as unresponsive, as described at step S780, operation of the method may continue to step S794.

In step S794, the collaborative solicitation server may notify contributors and/or members monitoring the categories/subcategories associated with the solicitation that no responsive responses were received and that the solicitation has been cancelled. Operation of the method may continue to step S796.

In step S796, the collaborative solicitation server may deduct overhead charges for conducting the solicitation, and operation of the method may continue to step S798.

In step S798, the collaborative solicitation server may electronically return the contributed funds, minus the deducted overhead charges, to the soliciting member and/or contributing members. Once funds have been distributed, operation of the method may continue to step S799 and may terminate.

As described above with respect to FIG. 1, controller 118 may receive and process data extracted from communications with member stations by user/member interface unit 117 and may control the execution of actions performed by each of the respective units described above in accordance with process flows controlled by controller 118. Further, with support from user/member interface unit 117, e.g., in performing user interface formatting, data insertion and data extraction activities, controller 118 may control exchanges of data between collaboration server 100 and the respective member stations via a user interface that may allow member stations to communicate with the collaborative solicitation controller via an interactive, visual display based user interface, such as the exemplary user interface described below with respect to FIG. 12 through FIG. 21.

FIG. 12 is an example of top-level display, or homepage 1200, that may be presented to a member station by a collaborative solicitation server via a LAN, WAN and/or Internet based network connection. For example, in one exemplary embodiment, homepage 1200 may be transmitted from a collaborative solicitation server to a WWW browser executing on a member station, via a LAN, WAN and/or Internet based network connection in response to the member station requesting a uniform resource locator (URL) associated with homepage 1200 of the collaborative solicitation server's user interface. A user may interact with the collaborative solicitation server via homepage 1200 and other user interface displays accessible to the user via homepage 1200.

As shown in FIG. 12, homepage 1200 may include a session login section 1202, a main control tab section 1204, a current solicitation, or demand, section 1206, a top solicitation, or demand, section 1207, a view tab section 1208 and a search section 1209.

Session login section 1202 may include a username/e-mail address entry block 1210, a password entry block 1212, a login button 1214, and a sign-up button 1216. Certain features shown in FIG. 12 may be accessible to any member station, while other features shown in FIG. 12 may be accessible only to member stations with which an authenticated session has been established between the member station and the collaborative solicitation server. For example, a user wishing to establish an authenticated session between his computer and the collaborative solicitation server may select sign-up button 1216 to create a member account on the collaborative solicitation server. When creating a member account, a user may be asked for identification and contact information, and may be asked to provide a credit card and/or other method of payment. Further, the user may be asked to provide a unique username and/or a unique email address, as well as asked to define a secure password. Once a user has established a member account, the user may establish an authenticated session between any member station and the collaborative solicitation server by providing his username or email address or password at username/e-mail address entry block 1210, providing his secure password at password entry block 1212, and selecting login button 1214.

Main control tab section 1204 may include a home tab 1218, a my account tab 1220, a channels tab 1222, a support tab 1224, an about us tab 1226, an upload tab 1228 and a demand tab 1230. The tabs provided in main control tab section 1204 allow a user to navigate to different interface displays supported by the collaborative solicitation server user interface by clicking on the respective tabs. For example, a user may navigate to homepage 1200 by clicking on home tab 1218. Once a tab is selected, main control tab section 1204 may be updated to display a banner associated with the tab selected, and may visually update the tabs to appear as though the selected tab has moved to the front of the respective tabs. In one exemplary embodiment, my account tab 1220 and demand tab 1230 may be active only after a user has established an authenticated session, as described above. User interface displays accessible via each of the tabs presented in main control tab section 1204 are described in greater detail, below.

Current demand section 1206 may present a user with a scrollable listing of ongoing solicitations, or demands. Each demand listing in the scrollable list may include a clickable title link 1238, that will allow a user to access detailed information related to the demand, a dynamically updated total pledged sum 1237, a dynamically updated time left value 1239, and a contribute button 1240, which may be active only during authenticated sessions. For example, current demand section 1206 may be used by a curious user to scroll up and down through a listing of active demands using the list scroll bar 1241. If interested, a user may obtain a display with more information related to a specific demand by clicking the clickable title link 1238 associated with the demand of interest. A user may contribute money to the demand by clicking contribute button 1240 associated with the demand of interest and authorizing, via a payment authorization display, a payment that will be added to the dynamically updated total pledged sum 1237 associated with the demand. Further, a user may click on title button 1232 to sort the listing of demands by title, may click on the value column header 1234 to sort the listing of demands by total pledged sum values, and may click on the time left column header 1236 to sort the listing of demands by the time remaining until conclusion of the demand.

Top demand section 1207 may present a user with a scrollable listing of ongoing solicitations, or demands, with total pledged sums over a predetermined value, e.g., over $4,000. Each demand listing in the scrollable list may include a clickable title link 1248, that may allow a user to access detailed information related to the demand, a dynamically updated total pledged sum 1247, and an indicator of a type of content item solicited by the demand 1249. For example, most recent demand section 1207 may be used by a curious user to scroll up and downs through a listing of active demands with the highest total pledged sums using scroll bar 1243. If interested, a user may obtain a display with more information related to a specific demand by clicking the clickable title link 1248 associated with the demand of interest. Further, a user may click on title column header 1242 to sort the listing of demands by title, may click on the top values column header 1244 to sort the listing of demands by total pledged sum, and may click on the type column header 1246 to sort the listing of demands by the content items types solicited.

View tab section 1208 may include a video tab 1250, a music tab 1252, a software tab 1254, an imagery tab 1256, a products tab 1258, and a services tab 1260. The tabs provided in view tab section 1208 may allow a user to set view tab section 1208 to display submissions based on the types of content items addressed by the submission. For example, a user may view submissions containing video content items in view tab section 1208 by clicking on video tab 1250; a user may view submissions containing music content items in view tab section 1208 by clicking on music tab 1252; a user may view submissions containing software content items in view tab section 1208 by clicking on software tab 1254; a user may view submissions containing imagery content items in view tab section 1208 by clicking on imagery tab 1256; a user may view submissions containing product content items in view tab section 1208 by clicking on products tab 1258; and a user may view submissions containing service content items in view tab section 1208 by clicking on services tab 1260.

In one exemplary embodiment, view tab section 1208 may include a tabbed highlighted submissions list 1269, a featured submission 1271, and a search section 1209. As shown in the example presented in FIG. 12, tabbed highlighted submissions list 1269 with scroll control 1271 may include a most recent submissions tab 1262 that presents a scrollable list of most recent submissions, a most viewed submissions list 1264 that presents a scrollable list of the most highly viewed submissions, and a highest rated submissions list 1266 that presents a scrollable list of the most highly rated submissions. Each submission in the list may include a submission image 1267 associated with the submission and a submission header 1268. A user may view the submission and/or additional information about the submission by clicking on one of submission image 1267 and submission header 1268.

Featured submission 1271 may present a featured submission image 1272 and a submission header 1273. A user may view the featured submission and/or additional information about the featured submission by clicking on one of featured submission image 1272 and featured submission header 1273.

Search section 1209 may include a search text box 1274, a search button 1275, and selectable content item type buttons 1276. For example, in one embodiment, regardless of the content item tab currently selected, e.g., video tab 1250, music tab 1252, software tab 1254, imagery tab 1256, products tab 1258 and services tab 1260, to view submissions, a user may initiate a search for submissions and demands associated with one or all content item types by selecting one or more of content item type buttons 1276, entering a search string in search text box 1274 and clicking search button 1275.

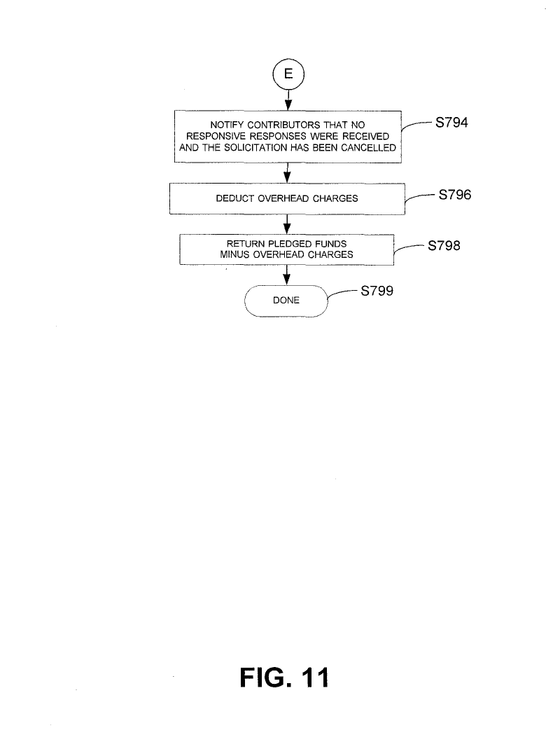

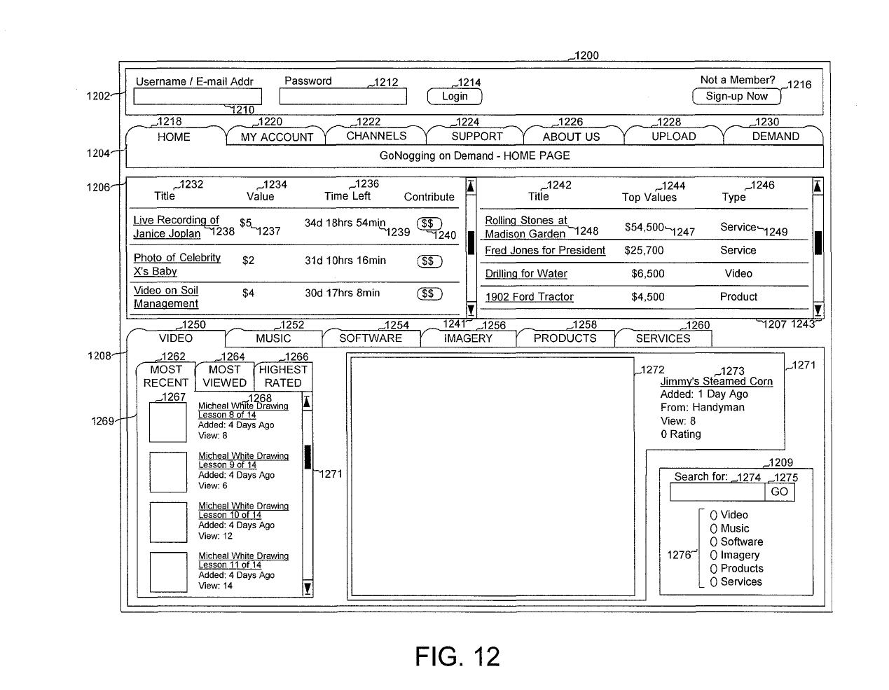

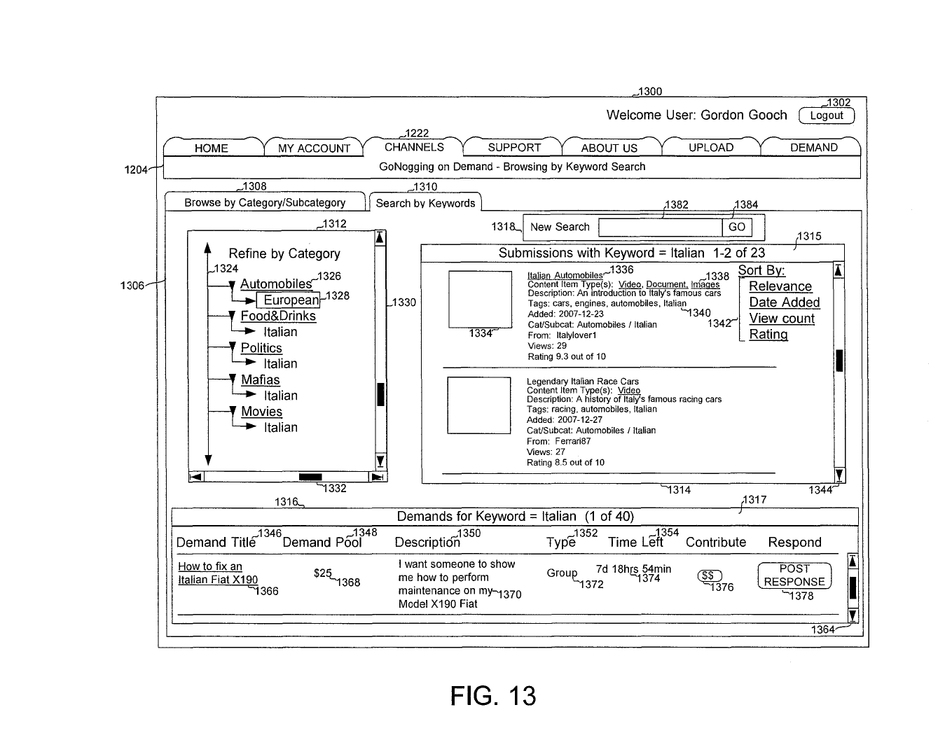

FIG. 13 is an example of a user interface display that may be displayed in response to a user selecting channels tab 1222, first described with respect to FIG. 12 and again presented in FIG. 13, followed by the user selecting the search by keywords tab 1310 in FIG. 13, described in greater detail below, or by a user initiating a search for submissions and demands via search section 1209 in FIG. 12, as described above. Please note that FIG. 13, and all subsequent display examples, assume that a user has logged into the collaborative solicitation server via session login section 1202 of FIG. 12 to create an authenticated session between a member station and the collaborative solicitation server. For this reason, the session login section 1202, shown in FIG. 12 has been replaced by logout button 1302. For example, by clicking on logout button 1302, a user may terminate an authenticated session and may return to homepage 1200, as shown in FIG. 12.

As shown in FIG. 13, such an exemplary display may include a logout button 1302, described above, main control tab section 1204, described above with respect to FIG. 12, and a tabbed search results viewing section 1306 that may include a browse by category/subcategory tab 1308, described below with respect to FIG. 14, and a search by keywords tab 1310. Search by keywords tab 1310 may include a category/subcategory tree section 1312, a scrollable list of submissions 1314, the submissions located using a keyword search, a scrollable list of demands 1316, the demands located using the same keyword search used to locate the submissions presented in scrollable list of submissions 1314, and a new keyword search section 1318.

Category/subcategory tree section 1312 may include a category/subcategory tree 1324, with one or more sets of branches and leaves. For example, the category/subcategory tree 1324 shown in FIG. 13 may display categories and subcategories associated with submissions returned as a result of a keyword search conducted using search section 1209, described above with respect to FIG. 12, with keyword=“Italian” with a selection of the “video” button of content item type buttons 1276.

In the example presented in FIG. 13, the submissions displayed in scrollable list of submissions 1314 and the demands displayed in scrollable list of demands 1316 may be associated with the categories and subcategories presented in category/subcategory tree 1324. Further, a user may reduce the number of submissions presented in scrollable list of submissions 1314 to submissions associated with a single subcategory and may reduce the number demands displayed in scrollable list of demands 1316 to demands associates with a single subcategory, by clicking on, for example, a single subcategory in category/subcategory tree 1324. For example, in FIG. 13, the subcategory European 1328 under category Automobiles 1326 has been selected so that only submissions and demands associated Italian automobiles are presented in scrollable list of submissions 1314 and scrollable list of demands 1316. In this manner, a user may sequentially browse submissions and demands associated with a common theme, e.g., Italy, for each of the categories/subcategories presented in category/subcategory tree 1324. The users view of category/subcategory tree 1324 may be adjusted using one or more of vertical scroll bar 1330 and horizontal scroll bar 1332, as desired by the user.

Scrollable list of submissions 1314 may include a header 1315, a vertical scroll bar 1344, a scrollable list of submissions, and a set of sorting criteria 1342. Each submission in the scrollable list may include a submission image 1334 and submission data that may include a submission header 1336, content item types 1338 and keywords 1340. In one exemplary embodiment, header 1315 may be used to display the keyword search criteria used to locate the submissions presented, and the total number of submissions presented, in the scrollable list of submissions as a result of the search. Further, in an exemplary embodiment such as the embodiment presented in FIG. 13, a user may click on submission image 1334 or submission header 1336 to view additional information related to the submission and/or to view the submission. In addition, a user may click on one of content item types 1338 associated with the submission. For example, as shown in FIG. 13, a user may click on one of “Video,” and “Images” to view information related to one of video content items and image content items, respectively, associated with the submission. Further, as shown in FIG. 13, a user may click on one of sorting criteria 1342 to sort the submissions shown in the scrollable list of submissions by one of several sorting criteria. For example, a user may click on “Relevance” to sort the submissions in the scrollable list of submissions by, for example, a highest determined relevance to the keyword search criteria, or a user may click on one of, for example, “date added,” “view count” and “rating” to sort the submissions in the scrollable list of submissions by the date each submission was submitted, the number of times each submission has been viewed or the viewer based evaluation ratings for each submission, respectively.

Scrollable list of demands 1316 may include a header 1317, a vertical scroll bar 1364, and a scrollable list of demands. As shown in FIG. 13, header 1317 may be used to display the keyword search criteria used to locate the demands presented in the scrollable list of demands as well as the total number of demands presented in the scrollable list of demands as a result of the search. Further, header 1317 may include column headers, such as demand title 1346, demand pool 1348, description 1350, type 1352, and a time left for execution of the demand 1354. In one exemplary embodiment a user may sort the demands listed in scrollable list of demands 1316 by clicking on the respective column headers.

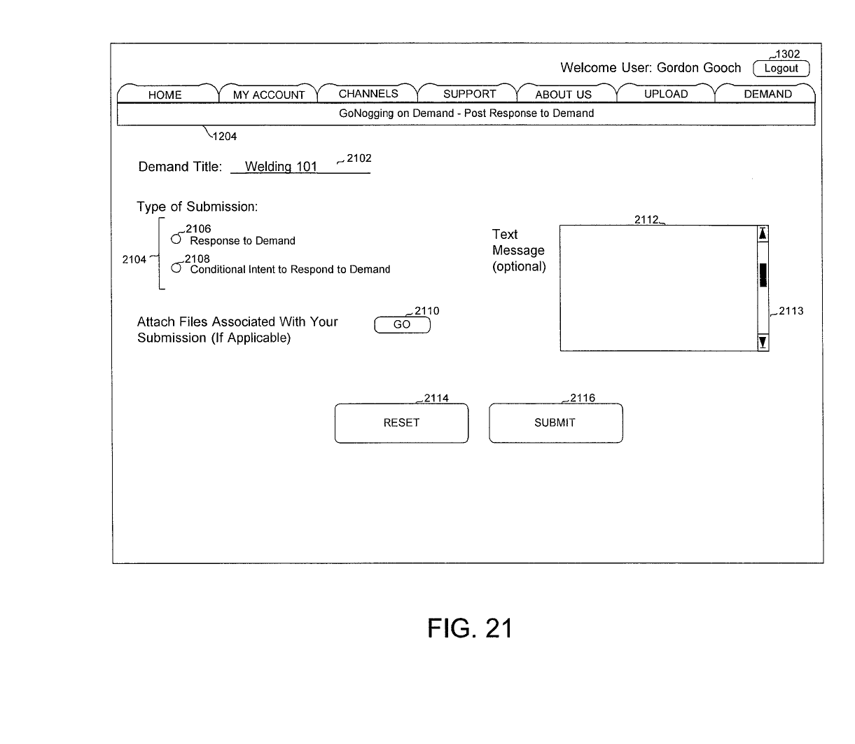

In one exemplary embodiment, each demand listing in the scrollable list may include a clickable demand title link 1366, that may allow a user to access detailed information related to the demand, a dynamically updated total pledged sum 1368, a demand title 1370, a solicitation type 1372, e.g., a private solicitation, a group solicitation, an open solicitation, a charitable solicitation, and a reverse solicitation, as described above, a dynamically updated time left value 1374, a contribute button 1376, and a post response button 1378. For example, scrollable list of demands 1316 may be used by a curious user to scroll up and downs through a listing of active demands using scroll bar 1364. If interested, a user may obtain a display with more information related to a specific demand by clicking the clickable title link 1366 associated with a demand of interest. A user may contribute money to the demand by clicking contribute button 1376 associated with the demand of interest and authorizing, via a payment authorization display, a payment that will be added to the dynamically updated total pledged sum 1368 associated with the demand. Further, a user may click on post response button 1378 to upload a submission in response to the demand, as described in greater detail with respect to FIG. 21.

As shown in FIG. 13, search section 1318 may include a search text box 1382 and a search button 1384. Should a user finish reviewing the submissions and demands returned a result of an earlier keyword search, the user may initiate a new keyword search by entering a new keyword search string in search text box 1382 and clicking search button 1384. As a result, scrollable list of submissions 1314, scrollable list of demands 1316, and the categories and subcategories presented in category/subcategory tree 1324, shown in FIG. 13, may be refreshed with the results of the new search.

FIG. 14 is an example of a user interface display that may be displayed in response to a user selecting channels tab 1222, first described with respect to FIG. 12 and again presented in FIG. 14, follow by the user selecting the browse by category/subcategory tab 1308, first described with respect to FIG. 13 and again presented in FIG. 14.

As shown in FIG. 14, such an exemplary display may include a logout button 1302, described above with respect to FIG. 13, main control tab section 1204, described above with respect to FIG. 12, and a tabbed search results viewing section 1306 that may include a search by keywords tab 1310, described above with respect to FIG. 13, and a browse by category/subcategory tab 1308. Browse by category/subcategory tab 1308 may include an expandable category/subcategory tree section 1412, a scrollable list of submissions 1414, the submissions located by clicking on a category or subcategory in category/subcategory tree section 1412, and a scrollable list of demands 1416, the submissions also located by clicking on a category or subcategory in category/subcategory tree section 1412. In one exemplary embodiment, the submissions and demands located by clicking on a category or subcategory in category/subcategory tree section 1412 are selected to include only those submissions and demands that include one or more of the content item types selected by the user using the content item types buttons 1276, described above with respect to FIG. 12.

Category/subcategory tree section 1412 may include an expandable category/subcategory tree 1424, with one or more sets of branches and leaves. For example, category/subcategory tree 1424 shown in FIG. 14 may be able to displays every category and subcategory defined in the collaborative solicitation server.

In the example presented in FIG. 14, the submissions displayed in scrollable list of submissions 1414 and the demands displayed in scrollable list of demands 1416 may be associated with a currently selected categories or subcategories presented in expandable category/subcategory tree 1424. Further, in one exemplary embodiment, the submissions displayed in scrollable list of submissions 1414 and the demands displayed in scrollable list of demands 1416 may be further selected to include only those submissions and demands associated with a currently selected categories or subcategories presented in expandable category/subcategory tree 1424 and that include one or more of the content item types selected by the user using the content item types buttons 1276, described above with respect to FIG. 12. For example, in FIG. 14, the subcategory “Italian” under category “Food&Drinks” has been selected so that only submissions and demands associated Italian food and drinks are presented in scrollable list of submissions 1414 and scrollable list of demands 1416. In this manner, a user may sequentially browse submissions and demands associated with each of the categories/subcategories presented in category/subcategory tree 1424. In one exemplary embodiment, the elements of expandable category/subcategory tree 1424 may be expanded to show underlying subcategories by clicking on a category or a subcategory marked with a horizontal arrow, for example, as shown in FIG. 14 next to category “Engineering” in category/subcategory tree 1424, and elements of expandable category/subcategory tree 1424 may be contracted to hide underlying subcategories by clicking on a category or a subcategory with a vertically aligned arrow, for example, as shown in FIG. 14 next to category “Food&Drinks” in category/subcategory tree 1424.

The features of scrollable list of submissions 1414 and the features of scrollable list of demands 1416 shown in FIG. 14 may operate in the same manner as described above with respect to scrollable list of submissions 1314 and scrollable list of demands 1316 with respect to FIG. 13 and, therefore, will not be again described with respect to FIG. 14.

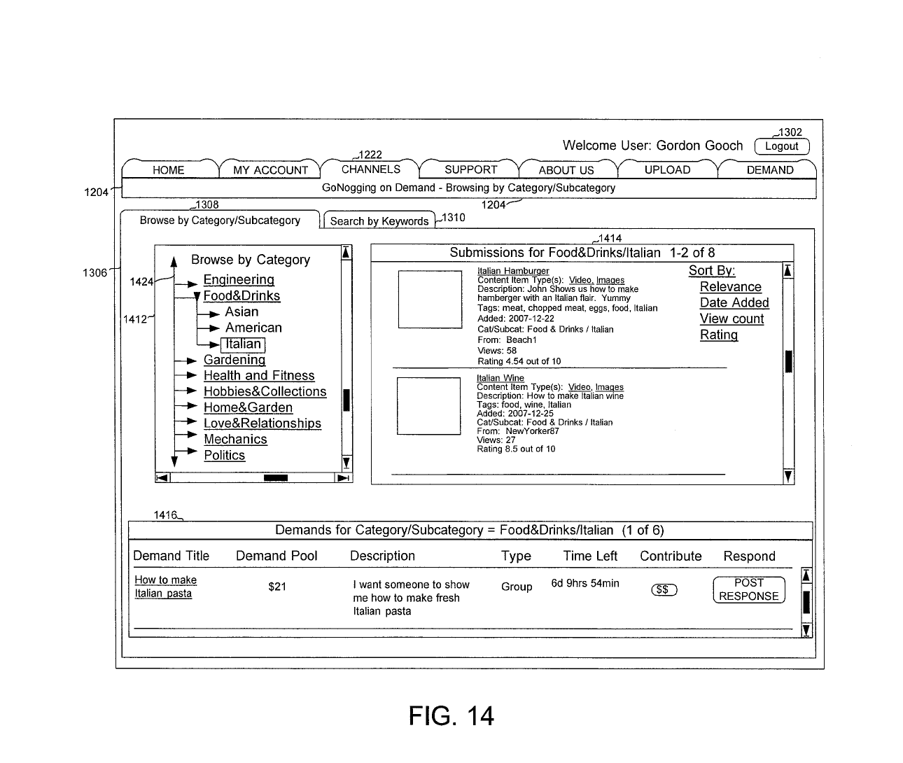

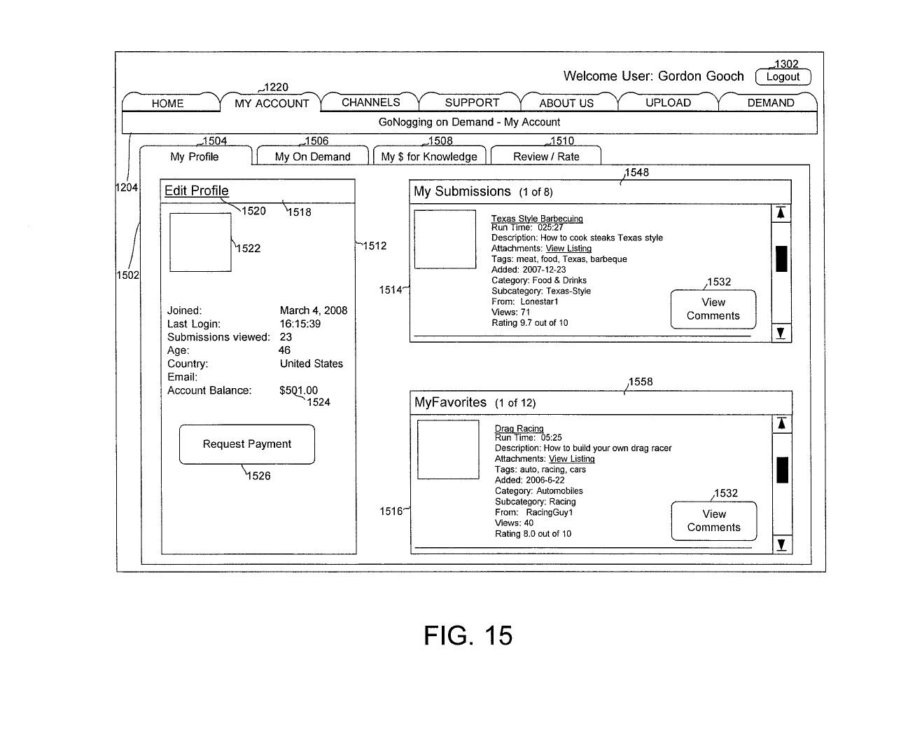

FIG. 15 is an example of a user interface display that may be displayed in response to a user selecting my account tab 1220 shown in FIG. 12, followed by the user selecting the my profile tab 1504 in FIG. 15.

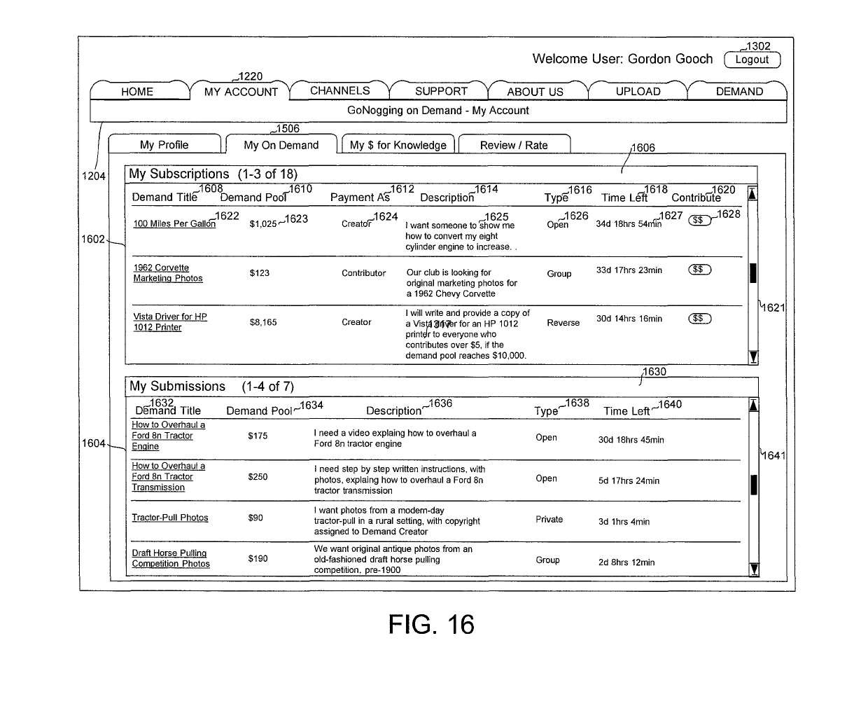

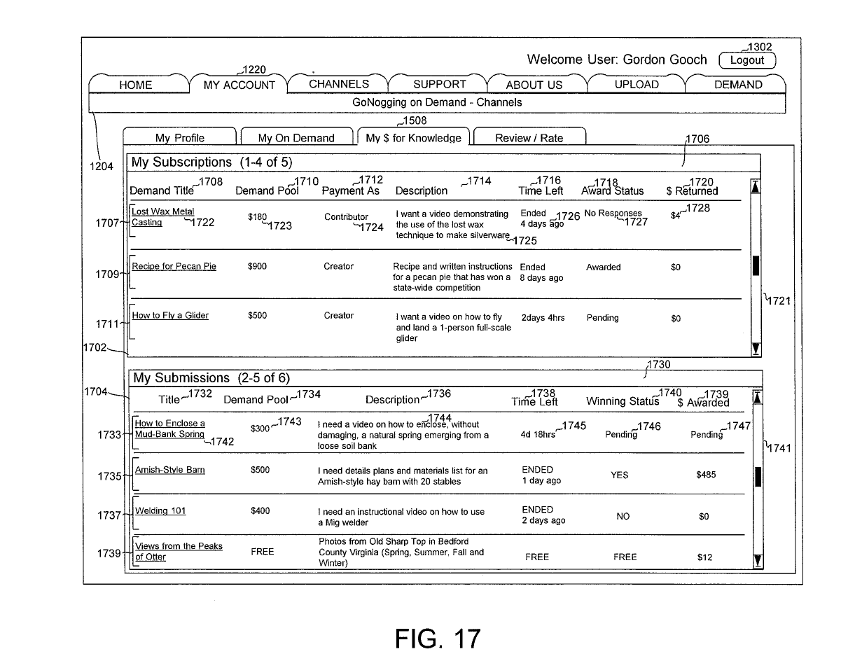

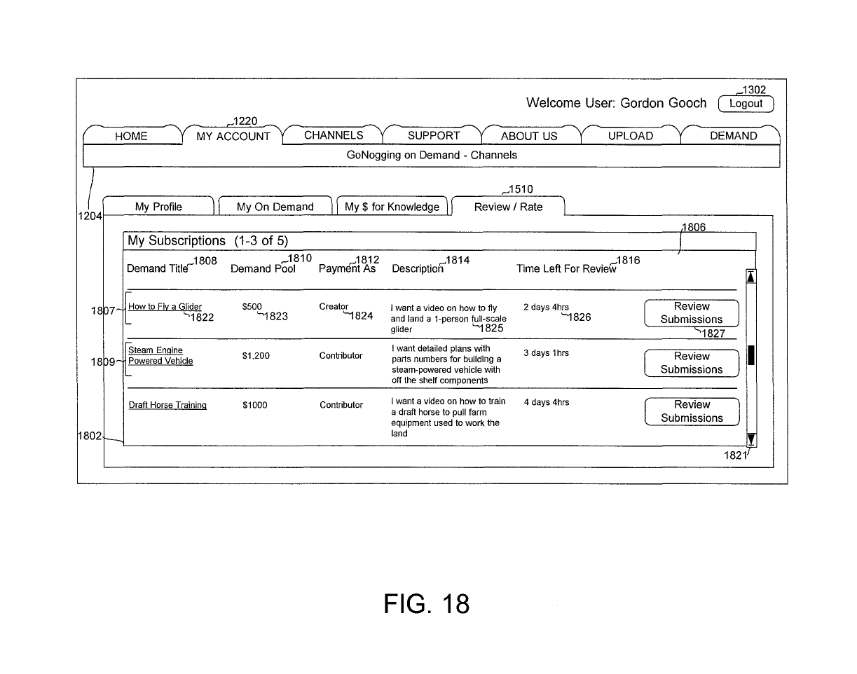

As shown in FIG. 15, such an exemplary display may include a logout button 1302, described above with respect to FIG. 13, main control tab section 1204, described above with respect to FIG. 12, and a tabbed my account section 1502 that may include a my profile tab 1504, a my on demand tab 1506, a my $ for knowledge tab 1508, and a review/rate tab 1510. As described above, FIG. 15 presents a display that assumes a user has selected my profile tab 1504. Features related to my on demand tab 1506 are described below with respect to FIG. 16, features related to my $ for knowledge tab 1508 are described below with respect to FIG. 17, and features related to review/rate tab 1510 are described below with respect to FIG. 18.

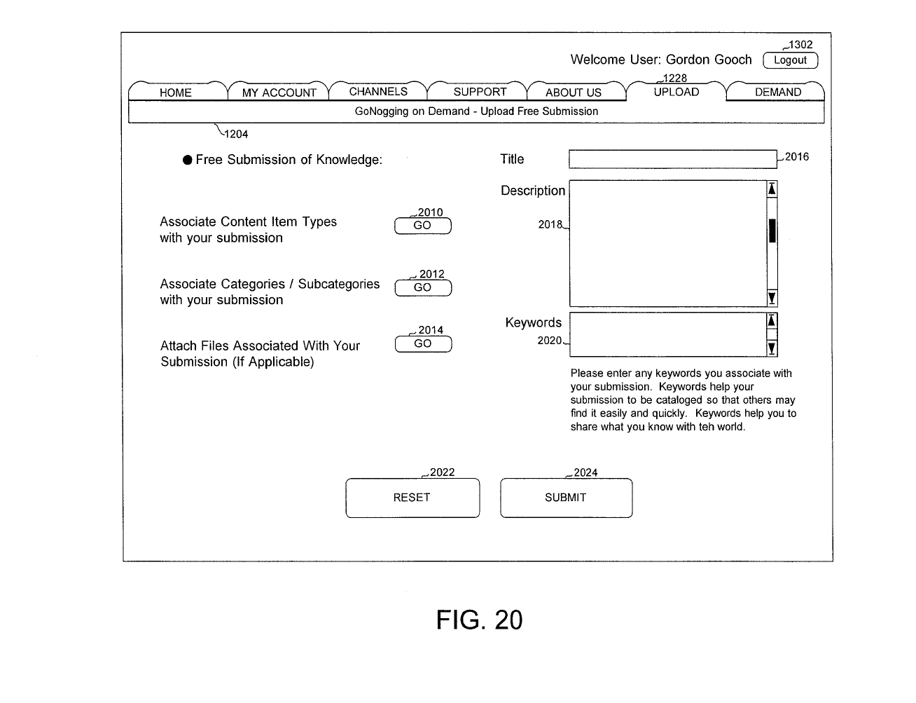

As shown in FIG. 15, my profile tab 1504 may include a user profile section 1512 that may be used to display user information and user account information, a scrollable submissions list 1514 that may be used to present a scrollable list of submissions uploaded by the user to the collaborative solicitation server, as described below with respect to FIG. 20 and FIG. 21, below, and a my favorites section 1516 that may be used to present a scrollable list of submissions uploaded to the collaborative solicitation by other users that the account user has viewed and selected for inclusion in his favorite submission lists.

User profile section 1512 may include a header 1518 with a clickable edit profile link 1520 that may allow a user to edit personal data stored in the user's profile, such as an image of the user, an age of the user, the user's country of origin, and an email address at which the user may be contacted. Further, as shown in FIG. 15, user profile section 1512 may display for periodic review by the user, the user's personal information, such as the user's image, as shown in FIG. 15 at 1522, the user's age, the user's country of origin, and the user's email address, as maintained by the user using the clickable edit profile link 1520. In addition, user profile section 1512 may display for periodic review by the user information about the user's activities that is automatically maintained by the collaborative solicitation server such as, the date the user created the current account, the time that has elapsed since the user logged in, a count of the submissions viewed by the user, and a dynamically updated account balance, as shown in FIG. 15 at 1524, that may reflect a balance owed to the user as a result of the user's activities on the collaborative solicitation server, as described below in greater detail with respect to FIG. 17. User profile section 1512 may also include a request payment button 1526, that may be selected by the user to request payment of all, or a portion of, the user's account balance.

Scrollable submissions list 1514 may include a header 1548 that may include a total count the number of submissions included in the scrollable list. The features associated with the individual submissions included in scrollable list of submissions 1514 are similar and may operate in the same manner as described above with respect to scrollable list of submissions 1414 described above with respect to FIG. 14 and, therefore, will not be again described with respect to FIG. 15. However, the submissions included in scrollable submissions list 1514 may be a list that includes only those submission uploaded to the collaborative solicitation server via the current user account. Further, each solicitation entry included in scrollable submissions list 1514 may include a view comments button 1532 that may be used to view comments submitted by various users after reviewing the submission.

Scrollable my favorites list 1516 may include a header 1558 that may include a total count the number of submissions included in the scrollable list. The features of scrollable my favorites list 1516, and the features of individual submissions included in scrollable my favorites list 1516 are similar and may operate in the same manner as features described above with respect to scrollable submissions list 1514, and, therefore, will not be again described. However, the submissions included in scrollable my favorites list 1516 may be a list that includes only those submissions selected for inclusion in the list by the user of the current account. Further, each solicitation entry included in scrollable my favorites list 1516 may include a view comments button 1532 that may be used to view comments submitted by various users after reviewing the submission.

FIG. 16 is an example of a user interface display that may be displayed in response to a user selecting my account tab 1220, first described with respect to FIG. 12 and again presented in FIG. 16, followed by the user selecting the my on demand tab 1506 first described with respect to FIG. 15 and again presented in FIG. 16.

The my on demand tab 1506 display presented in FIG. 16 may be accessed by a user to track the status of demands that are still open, for example, demands for which the response period remains open. For example, as shown in FIG. 16, demand tab 1506 may include a scrollable my subscriptions section 1602 and a scrollable my submissions section 1604.

Scrollable my subscriptions section 1602 may include a header 1606, a vertical scroll bar 1621, and a scrollable list of demands that the user has either created, or contributed to. As shown in FIG. 16, header 1606 may include a display of the total number of demands presented in the scrollable list of demands. Further, header 1606 may include column headers, such as demand title 1608, demand pool 1610, payment as 1612, description 1614, type 1616, time left 1618, and contribute 1620. In one exemplary embodiment a user may sort the demands listed in the scrollable my subscriptions section 1602 by clicking on the respective column headers.

In one exemplary embodiment, each demand listing in the scrollable list may include a clickable demand title link 1622, that may allow a user to access detailed information related to the demand, a dynamically updated total pledged sum 1623, a payment type 1624 that indicates whether payment was made as a creator of the demand or a contributor to the demand, a short description 1625 of the demand, a solicitation type 1626, e.g., a private solicitation, a group solicitation, an open solicitation, a charitable solicitation, and a reverse solicitation, as described above, a dynamically updated time left value 1627, and a contribute button 1628. For example, scrollable my subscriptions section 1602 may be used by a curious user to scroll up and downs through a listing of demands using scroll bar 1621. If interested, a user may obtain a display with more information related to a specific demand by clicking the clickable title link 1622 associated with a demand to which the user has already committed a financial interest. Based on his review, a user may contribute additional money to the demand by clicking contribute button 1628 associated with the demand of interest and authorizing, for example, via a pop-up payment authorization display, a payment that may be added to the dynamically updated total pledged sum 1623 associated with the demand.

Scrollable my submissions section 1604 may include a header 1630, a vertical scroll bar 1641, and a scrollable list of open demands which the user has made submissions. As shown in FIG. 16, header 1630 may include a display of the total number of demands presented in the scrollable list of open demands. Further, header 1630 may include column headers, such as demand title 1632, demand pool 1634, description 1636, type 1638, and time left 1640. In one exemplary embodiment a user may sort the demands listed in the scrollable my submissions section 1604 by clicking on the respective column headers.

The features of scrollable my submissions section 1604 may operate in the same manner as the features described above with respect to scrollable my subscriptions section 1602 and, therefore, will not be again described. Please note, however, that because the scrollable my submissions section 1604 tracks demands to which the user had made submissions, rather than demands to which the user has made financial contributions, columns such as “payment as” and “contribute,” as described above with respect to my open demand subscriptions section 1602 may be excluded from my submissions section 1604.

FIG. 17 is an example of a user interface display that may be displayed in response to a user selecting my account tab 1220 first described with respect to FIG. 12 and again presented in FIG. 17, followed by the user selecting the my $ for knowledge tab 1508 first described with respect to FIG. 15 and again presented in FIG. 17.

The my $ for knowledge tab 1508 display presented in FIG. 17 may be accessed by a user to track the status of dollars earned or returned from demands the user either created and/or contributed to, and to track the status of dollars earned from submissions uploaded to the collaborative solicitation server by the user in response to demands and to track the status of dollars earned from free submissions uploaded to the collaborative solicitation server by the user. Please note that any user may upload a free submission to the collaborative solicitation server so that the submission may be shared with others via the collaborative solicitation server. Free submissions may earn for the user uploading the free submission a share of the advertising revenue produced while other users view the free submission online. For example, in some embodiments, the operators of the collaborative solicitation server may present paid advertisements concurrently with collaborative solicitation server user interface displays, e.g., in the borders surrounding the collaborative solicitation server's user interface displays, and a user who submitted a content item being viewed during which time such advertisements are displayed may earn a portion of the advertising revenue earned.

As shown in FIG. 17, my $ for knowledge tab 1508 may include a scrollable my subscriptions section 1702 and a scrollable my submissions section 1704. Scrollable my subscriptions section 1702 may include a header 1706, a vertical scroll bar 1721, and a scrollable list of demands that the user has either created, or contributed to. Header 1706 may include a display of the total number of demands presented in the scrollable list of demands. Further, header 1706 may include column headers, such as demand title 1708, demand pool 1710, payment as 1712, description 1714, time left 1716, award status 1718 and a $ returned 1720. In one exemplary embodiment a user may sort the demands listed in the scrollable my subscriptions section 1702 by clicking on the respective column headers.

In one exemplary embodiment, each demand listing in the scrollable list may include a clickable demand title link 1722, that may allow a user to access detailed information related to the demand, a dynamically updated demand pool total pledged sum 1723 that indicates the total reached by the demand's pool, a payment type 1724 that indicates whether payment was made as a creator of the demand or a contributor to the demand, a short description 1725 of the demand, a dynamically updated time left value 1726 that indicates when the demand ended or will end, i.e., when the response review/rating period expired or will expire, an award status of the demand 1727 that may indicate, for example, one of whether the demand was awarded, whether the demand is pending awaiting the end of the review/rating period, or whether the demand is ended and no responses were received and a dollar value returned from prior contributions made to the ended demand that could not be awarded.

For example, the scrollable my subscriptions section 1702 shown in FIG. 17 presents three viewable closed demand subscription entries. For example, based on the values included in demand subscription entry 1707, i.e., demand pool=$180, payment as=contributor, time left=ended 4 days ago, status=no responses”, $ returned=$4, it appears that the current user contributed $4 as a contributor to a demand with a pool that reached $180, but that ended 4 days ago without receiving any responses. As a result, the $4 contributed is indicated as having been returned to an escrowed balance associated with the user's account.

Based on the values included in demand subscription entry 1709, i.e., demand pool=$900, payment as=creator, time left=ended 8 days ago, status=awarded, $ returned $0, it appears that the current user created a demand with a pool that reached $900, and that ended 8 days ago with an award to a respondent. Since the demand pool was awarded, no money may be scheduled to be returned to the user, however, the user will be entitled to the content items resulting from the demand, as defined in the demand solicitation control parameters. However, if the creator had, via the demand solicitation control parameters, reserved, for example, a 3% solicitation creator's fee in the solicitation control parameters controlling the demand, on a $900 demand fee, approximately $27 would have been awarded to the user as the creator of the demand, and the user would still be entitled to the content items resulting from the demand

Based on the values included in demand subscription entry 1711, i.e., demand pool=$500, payment as=creator, time left=2 days 4 hrs, status=pending, $ returned=$0, it appears that the current user also created a demand with a pool that reached $500, that will end in 2 days/4 hours. The remaining time in the demand is to provide viewers time to review and rate the submission received, as described in greater detail with respect to FIG. 18, below. Once all contributors have reviewed and rated the received submissions the demand may be awarded and proceeds resulting from the demand may be distributed, or returned, for example, if all responses are found to be non-responsive.

Scrollable my submissions section 1704 may include a header 1730, a vertical scroll bar 1741, and a scrollable list that may include an entry for: 1) each demand to which the user has uploaded a submission to the collaborative solicitation server; and 2) each free submission that the user has uploaded to the collaborative solicitation server. As shown in FIG. 17, header 1730 may include a display of a total number of entries presented in the scrollable list. Further, header 1730 may include column headers, such as title 1732, demand pool 1734, description 1736, time left 1738, winning status 1740 and a $ awarded 1741. In one exemplary embodiment a user may sort the entries listed in scrollable my submissions section 1702 by clicking on the respective column headers.

In one exemplary embodiment, each entry in the scrollable list may include a clickable title link 1742, that may allow a user to access detailed information related to the demand or free submission associated with the entry, a dynamically updated total pledged sum value 1743 that indicates for demand entries the total reached by the demand's pool, a short description 1744 of the demand or free submission, a dynamically updated time left value 1745 that indicates, for demand entries, when the demand will end, a user's winning status 1746 that indicates for each demand entry whether the user was a demand winner, and a dollar value awarded 1747 as a result of the user's submission to the demand or as a result of the user's free submission, as described above.

For example, the scrollable my submissions section 1704 shown in FIG. 17 presents four viewable submission entries. For example, based on the values included in my submissions entry 1733, i.e., demand pool=$300, time left=4 days 18 hrs, status=pending, $ awarded=pending, it appears that the current user submitted a response to a demand with a pool that has reached $300, but that demand does not end for another 4 days 18 hours. As a result, no money has been awarded awaiting the end of the demand, i.e., expiration of the demands review/rating period.

Based on the values included in my submissions entry 1735, i.e., demand pool=$500, time left=ended 1 day ago, winning status=yes, $ awarded=$485, it appears that the current user submitted a response to a demand with a pool that reached $500, and that ended 1 day ago. The user was declared a winner of the award and, according to the rules governing the solicitation, has been awarded $465 of the demand pool. The $35 deducted from the pool before the award may have been deducted to cover fixed overhead costs of the solicitation and/or a creator's fee for the originator of the solicitation, in accordance with the rules governing the demand solicitation.

Based on the values included in my submissions entry 1737, i.e., demand pool=$400, time left=ended 2 days ago, winning status=“NO”, $ Awarded=$0, it appears that the current user submitted a response to a demand with a pool that reached $400, and that ended 2 days ago, but that the user was not a winner of the demand, therefore no funds were awarded.

Based on the values included in my submissions entry 1739, i.e., demand pool=free, time left=free, winning status=free, and $ Awarded=$12, it appears that the current user submitted a free submission that has earned $12 in revenue since the user last asked for a payment.

A total of the dollar values returned and the dollar values awarded as described above with respect to FIG. 17 may be used to generate a dynamically updated account balance, as described above with respect to FIG. 15 at 1524, that may reflect a balance owed to the user as a result of the user's activities on the collaborative solicitation server.

FIG. 18 is an example of a user interface display that may be displayed in response to a user selecting my account tab 1220 first described with respect to FIG. 12 and again presented in FIG. 18, followed by the user selecting the review/rate tab 1510 first described with respect to FIG. 15 and again presented in FIG. 18.

The review/rate tab 1510 display presented in FIG. 18 may be accessed by a user to review and rate one or more submissions received in response to a demand the user either created and/or contributed to. The user is not required to review or rate a submission, however, should the review/rating period for a demand expire before the user has rated one or more submissions associated with the demand, an award will me made without the user's input.

As shown in FIG. 18, review/rate tab 1510 may include a scrollable my subscriptions section 1802. Scrollable my subscriptions section 1802 may include a header 1806, a vertical scroll bar 1821, and a scrollable list of demands that the user has either created and/or contributed to. Header 1806 may include a display of the total number of demands presented in the scrollable list of demands. Further, header 1806 may include column headers, such as demand title 1808, demand pool 1810, payment as 1812, description 1814, and time left 1816. In one exemplary embodiment a user may sort the demands listed in the scrollable my subscriptions section 1802 by clicking on the respective column headers.

In one exemplary embodiment, each demand listing in the scrollable list may include a clickable demand title link 1822, that may allow a user to access detailed information related to the demand, a dynamically updated demand total pledged sum 1823 that may indicate the total reached by the demand's pool, a payment type 1824 that may indicate whether payment was made as a creator of the demand or a contributor to the demand, a short description 1825 of the demand, a dynamically updated time left value 1826 that may indicate when the demand will end, i.e., when the response review/rating period will expire, and a review submissions button 1827 that may allow the user to review and to rate each submission associated with each demand or to assert that one or more submissions is non-responsive, as described above with respect to FIG. 10 at step S772 through S778 declare.

For example, the scrollable my subscriptions section 1802 shown in FIG. 18 presents three viewable demand subscription entries. For example, based on the values included in demand subscription entry 1807, i.e., demand pool=$500, payment as=creator, time left=2 days 4 hrs, it appears that the user has 2 days and 4 hours to review the submission received in response to the demand, or he loses his opportunity to do so.

Based on the values included in demand subscription entry 1809, i.e., demand pool=$1200, payment as=contributor, time left=3 days 1 hr, it appears that the user has 3 days and 1 hour to review the submission received in response to the demand, or he loses his opportunity to do so.

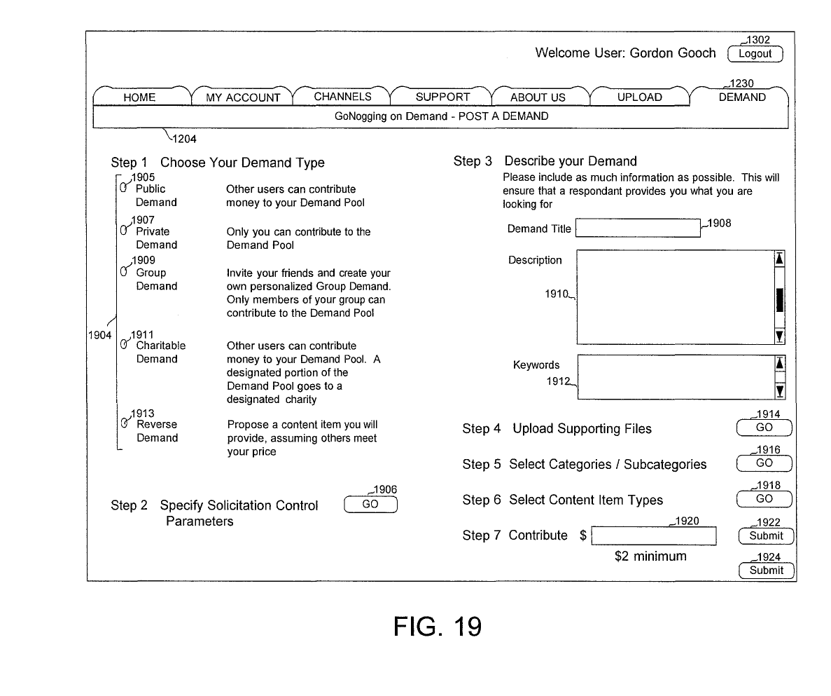

FIG. 19 is an example of a user interface display that may be displayed in response to a user selecting my account tab 1230 first described with respect to FIG. 12 and again presented in FIG. 19. The demand tab 1230 display presented in FIG. 19 may be accessed by a user to create and post a solicitation, or demand, to the collaborative solicitation server. Demand tab 1230 may provide a user with the ability to specify a demand type, e.g., a public demand, a private demand, a group demand, a charitable demand, a reverse demand, etc., to be associated with the new demand, specify solicitation control parameters that will govern the demand solicitation and award, provide a description of the demand and content items solicited by the demand, upload supporting data/files, associate the demand with categories/subcategories and keywords, associate the demand with 1 or more content item types, and to contribute an initial sum to the demand.

For example, as shown in FIG. 19, demand tab 1230 may include a plurality of selectable demand type check boxes 1904, an edit solicitation control parameters button 1906, a demand title entry text block 1908, a demand description text block 1910, a keywords text block 1912, an upload support files button 1914, a select categories/subcategories button 1916, a select content item types button 1918, an initial contribution entry text block 1920 and a submit button 1922, and reset button 1924.

In operation, a user may first select a demand type by clicking on one of demand type check boxes 1904. For example, clicking on the public demand check box 1905 would specify the demand as a public demand and any user would be allowed to contribute to the demand; clicking on the private demand check box 1907 would specify the demand as a private demand and only the demand creator would be allowed to contribute to the demand; clicking on the group demand check box 1909 would specify the demand as a group demand and a pop-up group member text block may be presented to the user allowing the user to specify, e.g., by entering an email address for each member, the members of the group allowed to contribute to the solicitation, clicking on the charitable demand check box 1911 would specify the demand as a charitable demand and any user would be allowed to contribute to the demand; and clicking on the reverse demand check box 1913 would specify the demand as a reverse demand and only the user creating the demand would be allowed to contribute to the demand.

Once a demand type has been selected, a user may click on edit solicitation control parameters button 1906 to edit a set of solicitation control parameters associated with the type of solicitation specified. Examples of the types of parameters used to control operation of a solicitation have been described in detail above and, therefore, will not be described again with respect to FIG. 19. The editable set of solicitation control parameters presented in response to a user selecting button 1906 may be tailored based on the type of solicitation, i.e., demand type, selected using demand type check boxes 1904 prior to presentation to the user, and may be preloaded with standard defaults which the user may view and change, if desired. Further, the editable set of solicitation control parameters may allow a user to provide information related to optional parameters, such as contact information, e.g., email addresses, for invitees to be notified of a demand.

A user may enter a title for the demand in demand title entry text block 1908, and may, via demand description text block 1910, enter a description of the content items to be provided and/or any additional information related to the demand that has not been addressed in the set of control parameters specified via edit solicitation control parameters button 1906. Further, a user may use keywords text block 1912 to specify a set of keywords that may be associated with the demand to facilitate search features, as described above, supported by the collaborative solicitation server. In addition, a user may select upload support files button 1914 to invoke, for example, a pop-up display that may allow the user to select and upload data files containing information, e.g., detail specifications, templates for responses, etc., to be associated with the demand and made available for download by demand respondents.

A user may use select categories/subcategories button 1916 to invoke, for example, a pop-up display that may allow the user to select one or more categories/subcategories to be associated with the demand. The categories/subcategories assigned to the demand may support such features as, for example, category/subcategory based browsing as described above with respect to FIG. 14, email notifications to users monitoring a select set of categories/subcategories, and/or other features that allow user to quickly and easily locate demands of interest. The select categories/subcategories pop-up display may allow a user to create one or more new category/subcategories within an existing category/subcategory tree maintained by the collaborative solicitation server, and may allow a user to then associate the one or more newly created category/subcategories with the demand, as described above with respect to FIG. 7 at step S706 through step S716.

A user may use select content item types button 1918 to invoke, for example, a pop-up display that allows the user to select one or more content items types to be associated with the demand. For example, the pop-up display may present a plurality of selectable demand content item check boxes, such as, for example, a video content item check box, a music content item check box, a software content item check box, an imagery content item check box, a products content item check box, and a services content item check box. The user may be allowed to select one or more of the content item check boxes presented. The content item types associated with a demand may be used to succinctly characterize the types of content items the demand is requesting, thereby allowing users interested in demands producing certain types of content items, e.g., video, music, software, imagery, products, services, etc, to more easily locate demand that produce such content items. Further, as described above with respect to FIG. 12, the content item types associated with a demand may be used to facilitate user browsing and searching features that may be supported by the collaborative solicitation server.

Once a user is satisfied that the demand has been accurately defined and described, the user may enter an initial contribution into initial contribution entry text block 1920 and click submit button 1922 to finalize and post the demand to the collaborative solicitation server. Should the user decide not to finalize and post the demand the user may reset the information entered into demand tab 1230 by clicking reset button 1924.

FIG. 20 is an example of a user interface display that may be displayed in response to a user selecting upload tab 1228 first described with respect to FIG. 12 and again presented in FIG. 20. The upload tab 1228 display presented in FIG. 20 may be accessed by a user to upload and post a free submission to the collaborative solicitation server. Further, the upload tab 1228 may provide a user with the ability to associate one or more content item types with the submission, associate one or more categories/subcategories with the submission, upload data files associated with the submission, provide a title for the submission, provide a short description of the submission, and provide keywords to be associated with the submission.

For example, as shown in FIG. 20, demand tab 1228 may include a select content item types button 2010, a select categories/subcategories button 2012, an upload files button 2014, a submission title entry text block 2016, a submission description text block 2018, a keywords text block 2020, a submit button 2022, and reset button 2024.

In operation, a user may use select content item types button 2010 to invoke, for example, a pop-up display that allows the user to select one or more content items types to be associated with the submission. For example, the pop-up display may present a plurality of selectable submission content item check boxes, such as, for example, a video content item check box, a music content item check box, a software content item check box, an imagery content item check box, a products content item check box, and a services content item check box. The user may be allowed to select one or more of the content item check boxes presented. The content item types associated with a submission may be used to succinctly characterize the types of content items the submission is providing, thereby allowing users interested in submissions providing certain types of content items, e.g., video, music, software, imagery, products, services, etc, to more easily locate submissions that provide such content items. For example, as described above with respect to FIG. 12, the content item types associated with a submission may be used to facilitate searching and browsing of submissions.

A user may use select categories/subcategories button 2012 to invoke, for example, a pop-up display that allows the user to select one or more categories/subcategories to be associated with the submission. The categories/subcategories assigned to the submission may support such features as, for example, category/subcategory based browsing as described above with respect to FIG. 14, email notifications to users monitoring a select set of categories/subcategories, and/or other features that allow users to be notified of and/or to quickly and easily locate submissions of interest.

In addition, a user may select upload support files button 2014 to invoke, for example, a pop-up display that may allow the user to select and upload data files containing content items associated with the free submission.

A user may enter a title for the submission in submission title entry text block 2016, and may, via submission description text block 2018, enter a description of the subjects and/or content items provided by the submission. Further, a user may use keywords text block 2020 to specify a set of keywords that may be associated with the submission to facilitate search features, as described above, supported by the collaborative solicitation server.

Once a user is satisfied that the submission has been accurately defined and described, the user may click submit button 2024 to finalize and post the submission to the collaborative solicitation server. Should the user decide not to finalize and post the submission the user may reset the information entered into submission tab 1228 by clicking reset button 2022.

FIG. 21 is an example of a post response to demand user interface display that may be presented to a user in response to the user clicking on a post response button associated with a demand listing, as described above, for example, with respect to FIG. 13 at 1378. Similar to the upload tab described above with respect to FIG. 20, the post response to demand display 2100 may be used to upload and post a submission. However, unlike the upload tab described above with respect to FIG. 20, the post response to demand display 2100 may be used to post a submission in response to an open demand.

For example, as shown in FIG. 21, post response to demand display 2100 may include a demand title display text block 2102 that is preloaded with the title of the demand associated with the post response button activated by the user to invoke post response to demand display 2100, set of selectable submission type buttons 2104, which may include a selectable response to demand checkbox 2106 and a selectable conditional intent to respond to demand checkbox 2108, an upload files button 2110, a scrollable text message text block 2112, a submit button 2114, and reset button 2116.

Please note that many of the submission identifiers associated with uploading a free submission to the collaborative solicitation server, as described with respect to FIG. 20, above, may not be required because the collaborative solicitation server may associate the demand response submission with categories/subcategories, content item types, and keywords already associated with the demand in response to which the submission is being uploaded.

In operation, after clicking a post response button associated with a demand, a user may select one of response to demand checkbox 2106 and selectable conditional intent to response to demand checkbox 2108 to identify the response as either a conditional intent to respond, or an actual response to the identified demand. If the response is a response to demand with submissions, the user may click upload files button 2110 to invoke, for example, a pop-up display that may allow the user to select and upload one or more files associated with the submission. Further, if the user wishes to upload any data files in association with a conditional intent to respond he may do so by using click upload files button 2110 to invoke, for example, a pop-up display to select and upload one or more files associated with the conditional intent to respond. Optionally, a user may submit a text message to be associated with the response in scrollable text message text block 2112.

Once a user is satisfied that the response to demand has been accurately defined and described, and all related files have been attached, the user may click submit button 2114 to finalize and post the response to the collaborative solicitation server. Should the user decide not to finalize and post the response the user may reset the information entered into response to demand display 2100 by clicking reset button 2116.

In the exemplary process flow described above with respect to FIG. 7 through FIG. 11 and the exemplary user interface described above with respect to FIG. 12 through FIG. 21, a content item requested by a solicitation may include any product and/or service. For example, based on the type of solicitation, e.g., a private solicitation, a group solicitation, an open solicitation, a charitable solicitation, a reverse solicitation etc., as described above, a requested and/or proposed content item may be a physical product, an electronic information product that may be electronically stored, copied and/or transferred electronically across a network, and/or any act or service the performance of which may be verified or documented via an item that may be electronically stored, copied and/or transferred electronically across a network.

For example, an exemplary open solicitation may request an item such as a video recording that may be posted to the knowledge base as a video content item. For example, a solicitation may request production of a video recording on how to repair a transmission on a 1952 Ford model 9N tractor, or an educational video recording that would support an elementary school level discussion of photosynthesis. The solicitation could provide a detailed description of the subject matter and/or issues to be addressed by the video recording, and/or other features such as the run-length of the video recording, languages that should be supported by the audio track, etc. The solicitation may include an attached set of specifications for the requested video recording based on, for example, a form provided by the new solicitation information processing unit 204, as described above with respect to FIG. 2 and as described with respect to step S718 of FIG. 7. In addition, the user may include in the solicitation a set of criteria against which all solicitation responses will be judged. Additional attachments to the solicitation specification may address issues such as copyright ownership of the content item to be produced, mechanisms that may be used to distribute the produced video recording, minimum fees to be paid, if any, to the respondent for each copy of the video recording produced or sold by the soliciting member, and/or any other requirements that a respondent that submits a response should comply in order for the response to be considered responsive. The solicitation may allow the respondent to suggest changes to the solicitation based on a conditional intent to respond, as described above with respect to FIG. 2 at block 212, and in FIG. 9 at step S752 through step S756. Such changes may be accepted in whole, modified, or rejected in whole, in a response to the conditional intent to respond posted as a subsequent edit to the original solicitation posting by the soliciting member.

By way of a second example, an exemplary open solicitation may request the production of a piece of freeware software that is either stand-alone or that is to act as a component within an existing system, such as a driver that supports a new input/output specification and that is compatible with a freeware operating system, such as Linux. The solicitation could provide a detailed specification based, for example, on a specification issued by an acknowledged Linux standards committee. The solicitation may also identify individuals who will assess the compliance of the submitted software against the specification. In such a manner, the cost of producing software may be distributed to those most interested in the development of the software, e.g., the millions of current Linux users, and software talent all over the world may be provided the opportunity to participate in the development, thus greatly expediting the likelihood that the software will be produced in a timely manner and thereby allowing operating system such as Linux to compete with large software enterprises such as Microsoft.

By way of a third example, an exemplary open solicitation may request a celebrity, performer, or group of performers to schedule a performance in a specified geographical area. Such a solicitation may be used, for example, by fans of the celebrity to encourage the celebrity to schedule a concert in their community and/or to encourage a group to conduct a rumored reunion tour by demonstrating fan interest and by providing an additional financial incentive. Such a solicitation may specify what must be done by representatives of the celebrity, performer, or group of performers before the funds may be collected. For example, distribution of the funds may be made contingent on the occurrence of the performance, or the mere scheduling the performance and placing tickets for the performance on sale. Further, the solicitation may require that contributors to the solicitation be provided with access to advanced ticket sales of prime seating locations.

By way of a fourth example, an open solicitation may offer funds that may become the property of an identified individual or celebrity, should the individual declare himself a candidate for an identified public office, such as president of the United States. Such a solicitation may be used, for example, by fans of the celebrity to encourage the celebrity to initiate a rumored run for public office by demonstrating popular support and by providing an additional financial incentive. Such a solicitation may specify what must be done by representatives of the candidate before the funds may be collected. For example, the funds may be made available to the candidate's campaign fund after the candidate announces his candidacy.

By way of a fifth example, an open solicitation may offer funds that may be used by a government official or agency for a specified purpose, such as for use in rewarding one or more individuals that the government official or agency knows provided information leading the arrest of a criminal, or the thwarting of a terrorist plot. Such a solicitation may provide officials with the financial ability to encourage would-be informants to provide information that would otherwise not be reported.

By way of a sixth example, an open solicitation may offer funds that may be received by a celebrity for performing a specified act in public and/or providing a photograph of the celebrity performing the specified act. For example, the solicitation may request the celebrity to provide a photograph of the celebrity with his/her new baby, or to serve as a guest speaker at a university graduation ceremony.

By way of a seventh example, an open solicitation may a offer funds as a reward to any individual who provides proof of an illegal act or wrongdoing by a government official, an elected official, and/or a candidate for office. For example, such a solicitation may offer funds to any individual who provides proof that a government official, elected official or candidates for office performed an illegal act or other wrongdoing that would imply that the individual is unworthy of the public's trust and/or unworthy of holding public office.

By way of an eighth example, a group solicitation may be used by members of an antique tractor club to solicit and obtain, for example, an antique tractor that the members wish to obtain for the club's collection.

By way of a ninth example, an open solicitation may be used to solicit an appearance or performance at a specified location, on a specified date, by a specified celebrity, artist or group, as described in the solicitation. In such an example, contributing members may receive free tickets, reduced ticket pricing and/or preferred seating based on the amount of their respective contributions. Should the number of physical tickets be exhausted before all contributing members have received a ticket, the contributing member may be provided with a free pay-per-view key code that will allow the contributing member to view a broadcast of the event via cable television and/or satellite television, free of charge.

By way of a tenth example, a charitable solicitation may be used by members to pool resources to solicit and obtain a physical product that may be delivered, for example, to a location/recipient designated by the solicitation. For example, contributing members may pool their contributions to fund the creation of a monument, or to obtain unique items for delivery to a museum or other recipient designated in the solicitation.

By way of an eleventh example, a charitable solicitation may be used by members to pool resources to solicit and obtain an appearance by, for example, a celebrity for the benefit of a national charity. The concert may be broadcast on a closed streaming media platform only accessible to those who contributed to the fund pool. If the celebrity decides to undertake the charitable event and produce the concert within the time specified, the charitable organization designated in the solicitation would receive a check for the amount of funds contributed.

By way of a twelfth example, a private solicitation may be used to solicit a specific photograph subject, detailing the exact content of the photograph(s). The solicitor may designate a price for the photograph(s), contribute funds to the pool, and designate a response time frame for the photograph(s) to be delivered. Such a solicitation would support what is known as a “Shooting on Spec” photography operation. If no photograph(s) is/are provided by a respondent to the solicitation, the solicitor may recoup his funds at the conclusion of the solicitation, minus overhead costs deducted as a fee for using the collaborative server to conduct the solicitation.

By way of a thirteenth example, an open solicitation may be used by a soliciting member to obtain a new software application or driver. The solicitation may provide a detailed description of the software product and a set of specific functions the software is to perform. The solicitor may set a time frame, e.g., 4 months, that reflects the time necessary to produce the software should sufficient funds be raised. Respondents may compete by submitting software that they believe meets the requirements. Those contributing the solicitation may evaluate the software submitted in response to the solicitation, and may vote on which response offers the most responsive content item. Contributed funds may be distributed as indicated in the solicitation, e.g., to 1st, 2nd and 3rd place winners, based on the number of votes each content item receives.

By way of a fourteenth example, an open solicitation may request production of a song by a specific artist or group of performers. The solicitation may request a specific song or may provide a subject matter or style for the requested song. Assuming contributing members contribute sufficient funds to convince the specific artist or group of performers to produce the song and to post an electronically formatted recording of the song, each contributor to the solicitation may be allowed to download a copy of the sound recording from the collaborative solicitation server.

By way of a fifteenth example, a reverse solicitation may be initiated by a software developer/soliciting member for a proposed new software application or new functionality to be added to an existing application and the soliciting member may set a minimum price and time frame for completion of the project. Members interested in the new application/functionality may contribute funds to the solicitation. Assuming the minimum price set by the soliciting member is met, and the soliciting member produces the software product described in the solicitation, the developer/soliciting member may release copies of the application to the respective contributing members.

The above exemplary solicitations allow individuals, anywhere in the world to pool their resources to offer incentive and motivation for the production of a content item that, otherwise, would not be produced. A solicitation may include a description of the content item to be produced as well as the criteria for award of the pledged funds. Such a solicitation may be of any format and contain any information necessary to clearly define requested content item and the criteria/method to be used in allocating pledged funds.

The described approach is self-regulating because contributing members are able to select the solicitations to which they contribute. If a potential contributing member believes that a solicitation specification is insufficient, that member may simply decide not to contribute funds to that solicitation. Therefore, the approach provides soliciting members with incentive to post clear, concise, and verifiable solicitations, if the solicitation is to attract contributing members and responses.

Embodiments of the collaborative solicitation apparatus, or collaborative solicitation server, may provide contributing members with the ability to rate or rank the performance of the soliciting member based on the results achieved with prior solicitation efforts. In this manner, a potential contributing member may base his decision to contribute to a solicitation based, in part, on a review of the soliciting member's performance in conducting successful and productive past solicitations.

For purposes of explanation, in the above description, numerous specific exemplary details are set forth in order to provide a thorough understanding of the described collaborative solicitation server. It will be apparent, however, to one skilled in the art that the described collaborative solicitation server may be practiced without all of these exemplary specific details. In other instances, well-known structures and devices are shown in block diagram form in order to avoid obscuring the features of the described collaborative solicitation approach.

While the described collaborative solicitation server has been described in conjunction with the specific embodiments thereof, it is evident that many alternatives, modifications, and variations will be apparent to those skilled in the art. Accordingly, embodiments of the collaborative solicitation server as set forth herein are intended to be illustrative, not limiting. There are changes that may be made without departing from the spirit and scope of the invention.

For example, it is to be understood that in exemplary embodiments, the described pledge period, described response period and described evaluation period may be configurable based on the needs of the solicitation, and may be arranged so as to overlap so that additional pledges may be received during the response period and/or individual evaluations may be performed during the response period once a response to a solicitation is received.

It is to be understood that a conditional intent to respond response may convey any information to the soliciting member that a potential responding member wishes to convey to the soliciting member. For example, a celebrity may state that he will comply with a requested act or service if a minimum level of total pledged funds reaches a designated value, e.g., $50,000. Further, the celebrity may designate that the pledged funds should be delivered directly to one or more designated charities. Alternatively, a conditional intent to respond response my request a clarification of a requirement or condition posted in the original solicitation.

Further, it is to be understood that if a solicited content item is an action or service, a posted content item related to the solicitation may be any document, photograph, or other proof that the action or service was performed.

Further, it is to be understood that various functions of the described functional units that support embodiments of the described collaborative solicitation server may be distributed in any manner among any quantity (e.g., one or more) of hardware and/or software modules or units that may be interconnected with circuitry and/or software interfaces.

Further, it is to be understood that references to stations, member stations, soliciting member stations, responding member stations, contributing member stations, etc., are references to network connected computing devices that may be operated by a human operator to communicate with the collaborative solicitation server to perform a task supported by the collaborative solicitation server, such as, initiating a solicitation, contributing to a solicitation, responding to a solicitation.

Further, it is to be understood that a member station may be any network connected computing device that may be operated by a human operator to communicate with the collaborative solicitation server. For example, a human operator may use a network connected computing device to open a username/password based account with the collaborative solicitation server. Thereafter, the human operator may use username/password authentication with collaborative solicitation server to identify himself in subsequent communications with the collaborative solicitation server using the same network connected computing device or another network connected computing device. Any network connected computing device used in such a manner may be referred to a member station.

The described member stations, e.g., solicitation member stations, contributing member stations, conditional intent to respond member stations and/or responding member stations may be performed, for example, by any device that supports, for example, an HTTP-based communication over a LAN, WAN and/or Internet based connection to the described collaborative solicitation server including, but not limited to workstation computers, laptop computers, cell phones, and personal digital assistants.

The described collaborative solicitation server and/or member stations may include any commercially available operating system (e.g., Windows, OS/2, Unix, Linux, DOS, etc.), any commercially available and/or custom software (e.g., communication software, etc.) and any types of input/output devices (e.g., keyboard, mouse, probes, I/O port, etc.).

Control software, or firmware, for the described collaborative solicitation server may be implemented in any desired computer language, and may be developed by one of ordinary skill in the computer and/or programming arts based on the functional description contained herein and illustrated in the drawings. For example, in one exemplary embodiment the described system may be written using the C++ programming language or the JAVA programming language. However, the present invention is not limited to being implemented in any specific programming language or combination of programming languages.

Any software associated with the described hardware/software platforms that support embodiments of the described collaborative solicitation server may be distributed via any suitable media (e.g., removable memory cards, CD-ROM, tape or other storage media diskette, network connection, etc.). Software and/or default control parameters may be installed in any manner (e.g., an install program, copying files, entering an execute command, etc.).

The described collaborative solicitation server may accommodate any quantity and any type of data set files and/or databases or other structures containing stored data in any desired format (e.g., ASCII, plain text, or other format, etc.). The format and structure of internal information structures, such as the described local data stores and control parameters used to hold intermediate information in support of the described member stations may include any and all structures and fields and may include, but are not limited to files, arrays, matrices, status and control booleans/variables.

Further, any references herein to software performing various functions generally refer to computer systems or processors performing those functions under software control. The computer system may alternatively be implemented by hardware or other processing circuitry. The various functions of the described stations that support embodiments of the described collaborative solicitation server may be distributed in any manner among any quantity (e.g., one or more) of hardware and/or software modules or units, computers or processing systems or circuitry.

From the foregoing description, it will be appreciated that a collaborative solicitation server that promotes the collaborative solicitation and development of content items is disclosed.

While a method and apparatus are disclosed that provide a collaborative solicitation server, various modifications, variations and changes are possible within the skill of one of ordinary skill in the art, and fall within the scope of the present invention. Although specific terms are employed herein, they are used in their ordinary and accustomed manner only, unless expressly defined differently herein, and not for purposes of limitation.

What is claimed is:

1. A computer system that allows system users to procure a content item by communicating with the computer system via a computer network, the system comprising:
a new solicitation unit that receives via the computer network from a first user solicitation data that defines the content item;
a solicitation posting unit that posts the solicitation data via a computer connected to the computer network as a solicitation, thereby allowing the solicitation to be accessed by other users via the computer network;
a pledge processing unit that receives via the computer network from each of a plurality of the other users, a monetary pledge to the solicitation and that updates the posted solicitation to include a total pledged sum based on the plurality of monetary pledges; and
a response processing unit that receives a response to the solicitation from a user via the computer network.

2. The system of claim 1, further comprising:
a solicitation data store that stores data related to the solicitation, wherein the solicitation data defines a content item that includes one or more of a video recording, an audio recording, a visual image, program instructions for execution by a computer, a promise to provide a service, a promise to perform an action, a promise to deliver a physical item, a proof that a service was provided, a proof the an action was performed, and a proof of delivery of a physical item.

3. The system of claim 2, further comprising:
a knowledge base data store that stores content items received in response to the solicitation, the received content items including one or more of a video recording, an audio recording, a visual image, program instructions for execution by a computer, a promise to provide a service, a promise to perform an action, a promise to deliver a physical item, a proof that a service was provided, a proof the an action was performed, and a proof of delivery of a physical item.

4. The system of claim 1, further comprising:
a funds disbursement unit that distributes at least a portion of the total pledged sum to a user who submitted the response.

5. The system of claim 4, wherein the funds disbursement unit is configurable to deduct a charge from the total pledged sum prior to distributing the portion of the total pledged sum.

6. The system of claim 5, wherein the funds disbursement unit is configurable to deduct a charge that is one of a fixed charge and a charge based on a percentage of the total pledged sum.

7. The system of claim 1, further comprising:
a response posting unit that posts the received response via a computer connected to the computer network; and
an evaluation unit that receives one or more evaluation ratings of the posted response.

8. The system of claim 7, further comprising:
a funds disbursement unit that distributes at least a portion of the total pledged sum to a user who submitted the response based, at least in part, on the received evaluation ratings.

9. The system of claim 1, further comprising:
a solicitation posting unit that posts the solicitation in association with one or more categories.

10. The system of claim 9, further comprising:
a member subscription unit that registers a user to monitor at least one of the one or more categories; and
a reporting unit that notifies the registered user of one of a newly posted solicitation and a newly posted response associated with the at least one category monitored by the registered user.

11. A method of conducting a solicitation to procure a content item via a computer network, the method comprising:
receiving via the computer network from a first user solicitation data that defines the content item;
posting the solicitation data via a computer connected to the computer network as a solicitation, thereby allowing the solicitation to be accessed by other users via the computer network;
receiving via the computer network from each of a plurality of the other users, a monetary pledge to the solicitation; and
updating the posted solicitation to include a total pledged sum based on the received plurality of monetary pledges.

12. The method of claim 11, wherein the solicitation defines a content item that includes one or more of a video recording, an audio recording, a visual image, program instructions for execution by a computer, a promise to provide a service, a promise to perform an action, a promise to deliver a physical item, a proof that a service was provided, a proof the an action was performed, and a proof of delivery of a physical item.

13. The method of claim 11, further comprising:
receiving a response to the solicitation from a user via the computer network.

14. The method of claim 13, wherein the response to the solicitation includes one or more of a video recording, an audio recording, a visual image, program instructions for execution by a computer, a promise to provide a service, a promise to perform an action, a promise to deliver a physical item, a proof that a service was provided, a proof the an action was performed, and a proof of delivery of a physical item.

15. The method of claim 13, further comprising:
distributing at least a portion of the total pledged sum to a user who submitted the response.

16. The method of claim 15, further comprising:
deducting a charge from the total pledged sum prior to distributing the portion of the total pledged sum.

17. The method of claim 16, wherein the deducted charge is one of a fixed charge and a charge based on a percentage of the total pledged sum.

18. The method of claim 13, further comprising:
posting the received response via a computer connected to the computer network; and
receiving one or more evaluation ratings of the posted response.

19. The method of claim 18, further comprising:
distributing at least a portion of the total pledged sum to a user who submitted the response based, at least in part, on the received evaluation ratings.

20. The method of claim 13, further comprising:
posting the solicitation in association with one or more categories.

21. The method of claim 20, further comprising:
registering a user to monitor at least one of the one or more categories; and
notifying the registered user of one of a newly posted solicitation and a newly posted response associated with the at least one category monitored by the registered user.

22. A program product apparatus having a computer readable storage medium with computer program logic recorded thereon, the computer program logic executable by a computer for procuring a content item via a computer network, the computer program logic comprising:
a new solicitation module that receives via the computer network from a first user solicitation data that defines the content item;
a solicitation posting module that posts the solicitation data via a computer connected to the computer network as a solicitation, thereby allowing the solicitation to be accessed by other users via the computer network;
a pledge processing module that receives via the computer network from each of a plurality of the other users, a monetary pledge to the solicitation and that updates the posted solicitation to include a total pledged sum based on the received plurality of monetary pledges; and
a response processing module that receives a response to the solicitation from a user via the computer network.
